(19) United States
(12) Patent Application Publication
(10) Pub. No.: US 2014/0369216 A1
(43) Pub. Date: Dec. 18, 2014

(54) COMMUNICATION DEVICE, RADIO COMMUNICATION SYSTEM, RADIO COMMUNICATION METHOD, AND TERMINAL

(71) Applicant: HITACHI, LTD., Tokyo (JP)

(72) Inventors: Tsuyoshi TAMAKI, Tokyo (JP); Hirotake ISHII, Tokyo (JP)

(21) Appl. No.: 14/306,516

(22) Filed: Jun. 17, 2014

(30) Foreign Application Priority Data
Jun. 18, 2013 (JP) 2013-127093

(51) Int. Cl. H04W 52/02

(52) U.S. Cl. CPC H04W 52/0229
USPC 370/252; 370/311

(57) ABSTRACT

Reception power of a terminal for a first communication scheme is measured. A propagation path loss between a base station and the terminal is calculated. The propagation path loss is estimated in a case where communications are conducted using a second communication scheme, and reception power of the terminal is estimated from output of the base station for the second communication scheme and the estimated propagation path loss. If the sufficiency and stability of the reception power are assumed, the switching from the first communication scheme to the second communication scheme is done. In this way, stable communications using the second communication scheme are ensured.

### CROSS-REFERENCE TO RELATED APPLICATION

This application claims the priority of Japanese Patent Application No. 2013-127093 filed Jul. 18, 2013, which is incorporated herein by reference in its entity.

### BACKGROUND OF THE INVENTION

1. Field of the Invention

The present invention relates to a communication method of enabling a radio communication system that handles a plurality of radio communication schemes or frequencies to switch to a suitable one.

2. Description of the Related Art

In radio communication systems represented by portable phones, high-speed data communications have been increasingly demanded, for example, due to the advent of smartphones. Mobile traffic is accordingly increasing rapidly.

Approaches of accommodating such rapidly increasing mobile traffic include: a method of increasing the number of usable bands for frequency resources; a method of improving frequency usage efficiency, which increases the amount of information to be transmitted among frequency resources restricted by the sophistication of radio communication schemes; a method of improving the entire capacity of a system by installing many base stations with low radio transmission output; and a method of accommodating traffic efficiently by combining a plurality of radio communication systems.

High-speed radio infrastructures that confirm to next generation radio communication schemes, such as the LTE (Long Term Evolution) and the WiMAX (Worldwide Interoperability for Microwave Access), are being prepared as communication systems that improve the sophistication of radio communication schemes or frequency usage efficiency. Furthermore, radio LAN services with low radio transmission output are provided in places (hotspots), such as stations and airports, where many people gather and increase the traffic. Using these radio communication systems accommodates heavy mobile traffic.

When the setting of the wireless LAN in a smartphone is left turned on, this smartphone repeatedly searches for a base station for wireless LAN within its surrounding area. As a result, the battery consumption disadvantageously increases. As the number of radio systems increases, a terminal searches for the radio systems at a higher frequency. Eventually, the disadvantage with regard to the battery consumption will become evident.

In the light of the above disadvantage, JP-2009-253569-A defines information, called ANDSF (Access Network Discovery & Selection Function), required to connect to a plurality of radio communication systems, and reports it to a terminal, providing a mechanism for allowing the terminal to select a suitable network. The policy of determining which of a wireless LAN and a cellular system is connected to a terminal can be set finely, depending on a time zone, a place, the congestion of a network, or the like.

A description will be given of a system configuration that switches between radio communication schemes, with reference to FIG. 1. This system configuration supports two radio communication schemes, or schemes A and B. When a terminal 111b is connected to the Internet 101 by using the scheme A, it is connected to the Internet 101 via a base station 109a, a carrier network 107 and a gateway (scheme A) 102. Then, an authentication device (scheme A) 104 performs terminal authentication and user authentication in order to identify whether the terminal 111b is a normally registered terminal or not. On the other hand, a terminal 111a is connected to the Internet 101 by using the scheme B through a configuration that is substantially the same as the above. A scheme switching server 105 reports information required to switch between the two communication schemes to the terminals 111a and 111b, being able to switch therebetween.

For example, assuming that the schemes A and B and the scheme switching server 105 are implemented using an LTE, a wireless LAN and an ANDSF server, respectively, the radio communication schemes for the LTE and the wireless LAN are switched between each other in accordance with the policy defined in the ANDSF server.

In the case where a wireless LAN system accommodates many users and many communications accordingly occur simultaneously, delay times of the communications increase because of the CSMA (Carrier Sense Multiple Access) that avoids conflicts of radio packets. If the traffic employs a best effort type, the delay times do not become problematic. However, if traffic requires real time property, an LTE or WiMAX system needs to be equipped with a mechanism for assuring the QoS. For this reason, it is necessary to install base stations with low radio transmission output which conform the LTE, WiMAX or the like at hotspots as described above, in addition to wireless LANs.

JP-2009-253569-A and JP-2012-23519-A disclose techniques for the same radio communication system, in which a system that combines small-cell base stations with a low radio transmission output and macro-cell base stations with a high radio transmission output is connected to small cells efficiently.

In JP-2009-253569-A, a small-cell base station intercepts a radio signal for a connection request that a terminal has transmitted to a macro-cell base station. Then, when the power of the received signal is equal to or higher than a preset threshold, the terminal is connected to the small-cell base station.

In JP-2012-23519-A, a terminal is connected to a base station that corresponds to a greater one of: a value obtained by adding an offset value to the power of a received signal that the terminal has received from a small-cell base station within its surrounding area; and the power of a signal that the terminal has received from the pertinent macro-cell base station.

### SUMMARY OF THE INVENTION

A disadvantage of radio communication systems that switch between two radio communication schemes is that the battery lift of a terminal decreases, because the terminal needs to search for a base station for the second radio communication scheme while conducting communications using the first radio communication scheme. In the light of this disadvantage, 3GPP TS 24.312 V11.4.0 (2012-09), “Access Network Discovery and Selection Function (ANDSF) Management Object (MO)”, p. 11-74 provides a method of allowing a terminal to be connected to the second radio scheme by reporting a connection policy from a server device to the terminal, depending on a time zone, a place and the congestion of a network. When a server device reports a connection policy that switches from the first communication radio scheme to the second radio communication scheme, however, conventional techniques fail to provide a mechanism for assuring the power stability of a radio wave that a terminal will receive by using a second radio communication scheme. Therefore, if the reception power of the terminal for the second radio scheme is low when the switch to the second radio communication scheme is done, it takes a long time to authorize the terminal, so that providing stable communications is disadvantageously failed.

In the conventional technique in JP-2009-253569-A, assuming that communications between the terminal and a macro-cell station use the first radio communication scheme and communications between the terminal and a small-cell station use the second radio communication scheme, the second radio base station needs to intercept a connection signal transmitted to the first radio base station. In this case, both base stations need to use the same frequency signal. Therefore, if the first and second radio communication schemes are implemented using the LTE and a wireless LAN, respectively, the control disclosed in JP-2009-253569-A cannot be performed.

The conventional technique in JP-2012-23519-A is predicated on a condition that the small-cell and macro-cell base stations conform to the same radio communication scheme. Thus, this technique is not designed to provide stable connections between different radio communication schemes.

According to a first solution, a terminal can conduct communications by using a first radio communication scheme and a second radio communication scheme, and a first communication device communicates with the terminal by using the first radio communication scheme. Further, the first communication device provides a base station including: a reception power measuring section that receives first reception power of the terminal for the first radio communication scheme; a control section that estimates reception power of the terminal for the second radio communication scheme, on the basis of first transmission power to the terminal for the first radio communication scheme, the first reception power acquired by the reception power measuring section, and second transmission power to the terminal from a second communication device that conducts communications by using the second radio communication scheme; and an output section that outputs information for switching from the first communication device to the second communication device, on the basis of a result of the estimation.

The reception power in the communication using the second radio communication scheme is estimated on the basis of the reception power measured during communications using the first radio communication scheme. The first radio communication scheme is therefore switched to the second radio communication scheme under the condition that the sufficiency and stability of the reception power are assured. In this way, stable communication using the second radio communication scheme can be assured. If the second radio communication scheme is implemented using a wireless LAN, the switching can be done while the reception power is stable. Consequently, it is possible to provide merits of eliminating the need to regularly perform a search process, thereby giving a long battery life to a terminal and avoiding unstable communications that would be caused, for example, when a connection to a wireless LAN is made at a place with low reception power.

### BRIEF DESCRIPTION OF THE DRAWINGS

FIG. 1 is an explanatory view showing a system configuration of a conventional technique that switches between communication schemes;

FIG. 2 shows a system configuration in Embodiment 1 of the present invention;

FIG. 3 shows a system configuration in Embodiment 2 of the present invention;

FIG. 4 is an explanatory, operational sequence diagram (Example 1) in Embodiment 1 of the present invention, in which the scheme A is switched to the scheme B;

FIG. 5 is an explanatory, operational sequence diagram (Example 2) in Embodiment 1 of the present invention, in which the scheme A is switched to the scheme B;

FIG. 6 is an explanatory, operational sequence diagram (Example 1) in Embodiment 1 of the present invention, in which the scheme B is switched to the scheme A;

FIG. 7 is an explanatory, operational sequence diagram (Example 2) in Embodiment 1 of the present invention, in which the scheme B is switched to the scheme A;

FIG. 8 is an explanatory, operational sequence diagram (Example 3) in Embodiment 1 of the present invention, in which the scheme B is switched to the scheme A;

FIG. 9A is an explanatory, operational sequence diagram in which the base station B in Embodiment 1 of the present invention transits from an active state to a sleep state;

FIG. 9B is an explanatory view of a base station state list in Embodiment 1 of the present invention;

FIG. 10 is an explanatory, operational sequence diagram in which the base station B in Embodiment 1 of the present invention transits from a sleep state to an active state;

FIG. 11A is an explanatory, operational sequence diagram in which the scheme switching server in Embodiment 1 of the present invention controls terminal states;

FIG. 11B is an explanatory view of a terminal state list in Embodiment 1 of the present invention;

FIG. 12 shows a configuration of the centralized base station A in Embodiment 1 of the present invention;

FIG. 13 shows a configuration of each modem A in the centralized base station A in Embodiment 1 of the present invention;

FIG. 14A is an explanatory view showing the control section in the centralized base station A in Embodiment 1 of the present invention;

FIG. 14B is an explanatory database with the base station B/radio device related information in Embodiment 1 of the present invention;

FIG. 15 is an explanatory view showing reception power information in the control section in the centralized base station A in Embodiment 1 of the present invention;

FIG. 16A is an explanatory flowchart of processing performed by the terminal reception power estimation processing section, which the control section in the centralized base station A in Embodiment 1 of the present invention has;

FIG. 16B is an explanatory database with a correction table in the terminal reception power estimation processing section, which the control section in the centralized base station A in Embodiment 1 of the present invention has;

FIG. 17 shows a configuration of the base station B in Embodiment 1 of the present invention;

FIG. 18 shows a configuration of the terminal in Embodiment 1 of the present invention;

FIG. 19 is an explanatory view showing the integrating device in Embodiment 1 of the present invention;

FIG. 20 is an explanatory, operational sequence diagram of inquiring the integrating device in Embodiment 1 of the present invention about a detected scheme;

FIG. 21 is an explanatory, operational sequence diagram in which the base station B in Embodiment 1 of the present invention is powered;

FIG. 22 shows a configuration of the scheme switching server in Embodiment 1 of the present invention;

FIG. 23 shows a system configuration of Embodiment 3 of the present invention; and

FIG. 24 shows a system configuration of Embodiment 4 of the present invention.

### DESCRIPTION OF THE PREFERRED EMBODIMENTS

The present example provides a communication system that switches between two radio communication schemes. Specifically, this communication system includes: a server device that judges the switching from a first radio communication scheme to a second radio communication scheme; a base station, a gateway and an authentication device for the first radio communication scheme; a base station, a gateway and an authentication device for the second radio communication scheme; and terminals. Further, the communication system estimates reception power of a terminal during communications using the second radio communication scheme, by using reception power for the first radio communication scheme. Then, if the estimated reception power is equal to or higher than a threshold, the server device reports that the first radio communication scheme will be switched to the second radio communication scheme, to the terminal.

With regard to the reception power for the first radio communication scheme, for example, the terminal receives a reference signal that the base station for the first radio communication scheme regularly transmits, and measures its reception power. Then, the terminal reports information regarding the measured reception power to the base station for the first radio communication scheme. In this way, the base station acquires the reception power for the first radio communication scheme.

Furthermore, the base station for the first radio communication scheme calculates a propagation path loss, from the difference between a transmission output for the first radio communication scheme and the above reception power, and adds an offset value to the propagation path loss, thereby estimating a propagation path loss for the second radio communication scheme. Then, the base station estimates reception power of the terminal for the second radio communication scheme, from the propagation path loss corresponding to the second radio communication scheme which has been estimated from the transmission output of the base station for the second radio communication scheme.

### Example 1

An embodiment of the present invention will be described below with reference to the drawings.

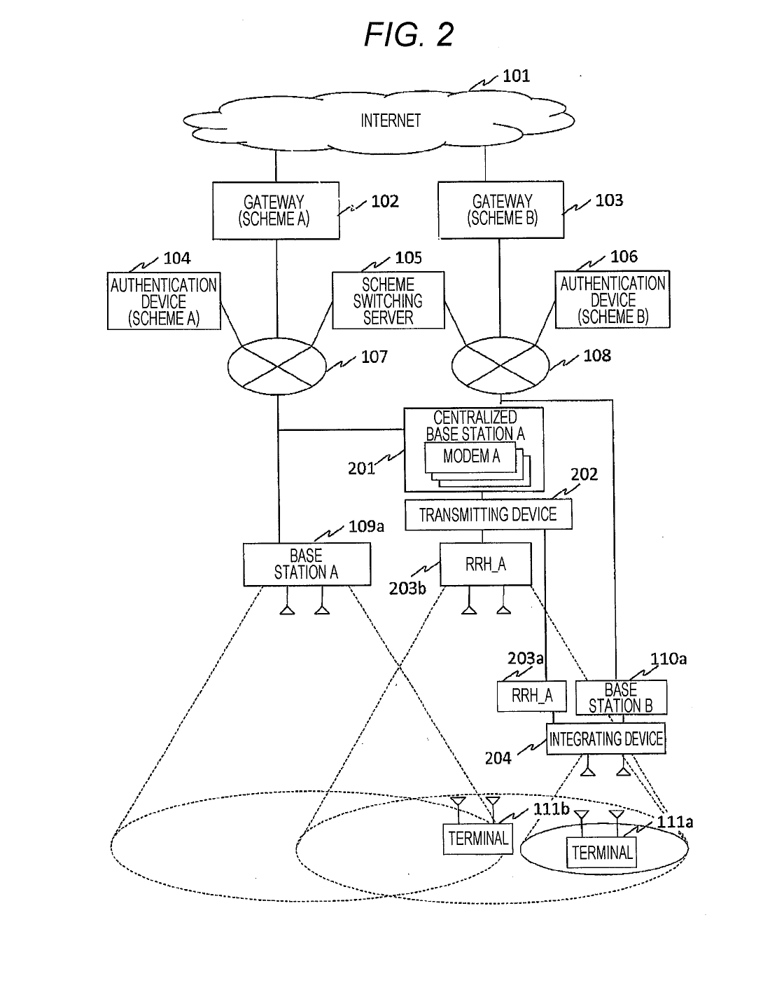

FIG. 2 shows a system configuration in Embodiment 1 of the present invention.

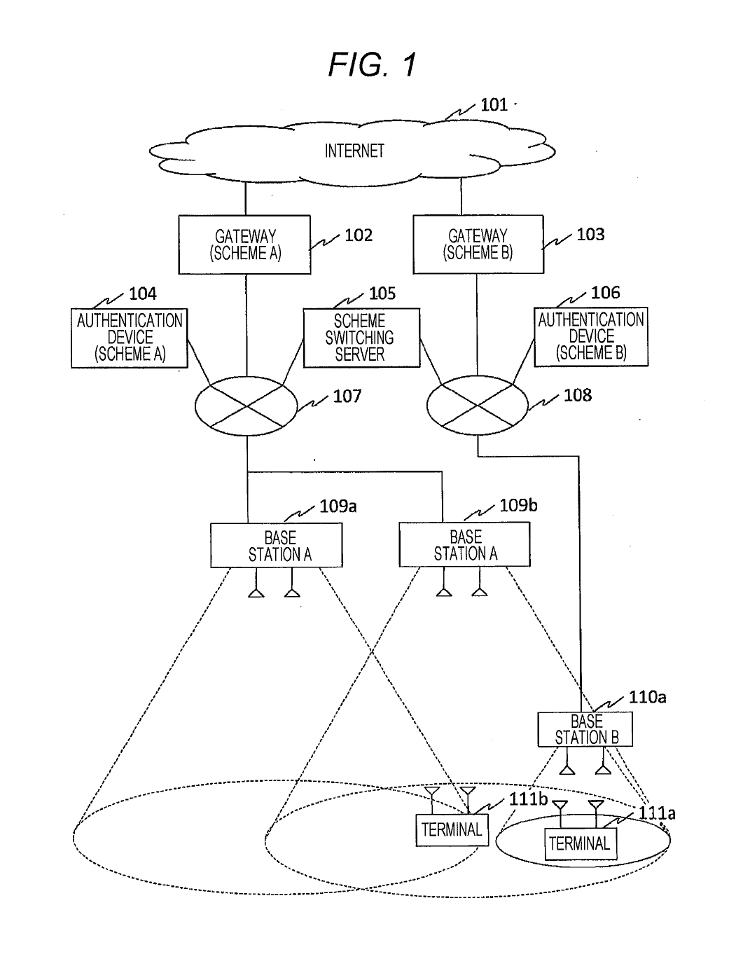

An Internet 101, a gateway (scheme A) 102, a gateway (scheme B) 103, an authentication device (scheme A) 104, an authentication device (scheme B) 106, a scheme switching server 105, a base station A 109a, a base station B 110a, a terminal 111a, and a terminal 111b have substantially the same system configurations as in those shown in FIG. 1. An integrating device 204 is installed in a transmission/reception antenna of the base station B 110a, so that this antenna handles both signals for the schemes A and B. A radio device RRH_A 203a, which transmits or receives signals for the scheme A, exchanges the signals for the scheme A with the integrating device 204. In addition, a radio device RRH_A 203b that transmits or receives signals for the scheme A is installed in the place where the base station A 109b is installed in FIG. 1, instead of the base station A 109b. The radio device RRH_A 203b is connected to a centralized base station A 201 through a transmitting device 202 that distributes or collects signals for the radio devices RRH_A 203a and 203b. The centralized base station A 201 has a plurality of modems for the scheme A. This centralized base station is equipped with baseband signal processing and Layers 2 and 3 functions of the modems. A single modem corresponds to a single radio device RRH_A 203a. A description will be given on the premise that Example 1 configures an architecture in which baseband signal processing functions, as described above, are integrated.

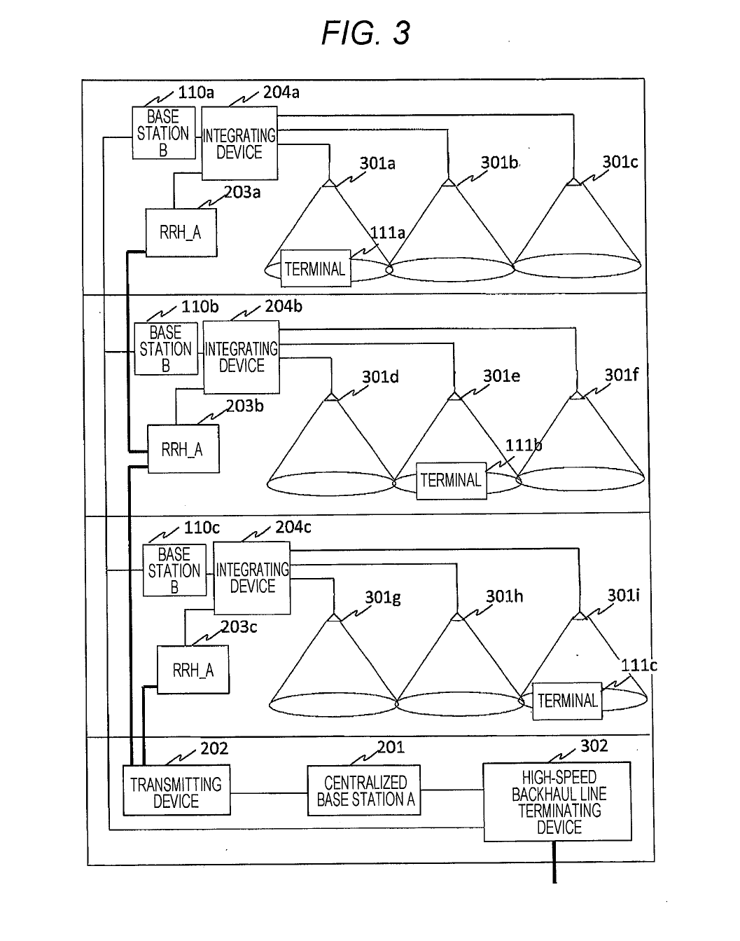

FIG. 3 shows a system configuration in Embodiment 2 of the present invention.

This system configuration shows a distributed antenna system (DAS) the covers the interior of a building or the like. The authentication device (scheme A) 104, the gateway (scheme A) 102 connected to the Internet 101, and the like shown in FIG. 2 are omitted. A high-speed backhaul line terminating device 302 that establishes a connection to the outside is connected to a carrier network 107 in FIG. 2. The centralized base station A 201 is connected to the radio devices RRH_A 203a and 203b and a radio device RRH_A 203c through the transmitting device 202. The base stations B 110a, 110b and 110c are connected to the high-speed backhaul line terminating device 302. An integrating device 204a integrates the outputs from the base station B 110a and the radio device RRH_A 203a and distributes it to antennas 301a to 301c. An integrating device 204b integrates the outputs from the base station B 110b and the radio device RRH_A 203b and distributes it to antennas 301d to 301f. An integrating device 204c integrates the outputs from the base station B 110c and the radio device RRH_A 203c and distributes it to antennas 301g to 301i. FIG. 2 is based on the premise that the range in which a radio wave from the base station B 110a is delivered is covered by the ranges to which radio waves from the radio devices RRH_A 203a and 203b are delivered. In contrast, in FIG. 3, the range in which a radio wave from the base station B 110a is delivered is covered by the radio device RRH_A 203a but not covered by the radio device RRH_A 203b.

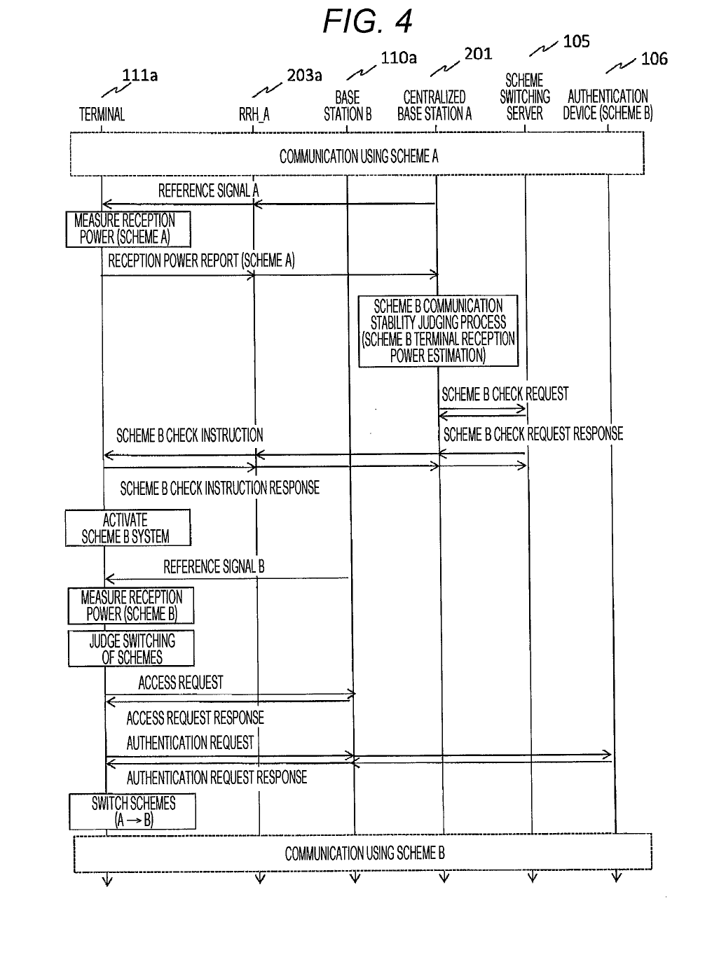

FIG. 4 is an explanatory, operational sequence diagram (Example 1) in Embodiment 1 of the present invention, in which the scheme A is switched to the scheme B. The terminal 111a is conducting communications using the scheme A. The centralized base station A 201 regularly transmits reference signals A via the radio device RRH_A 203a. When the terminal 111a receives a reference signal A, it measures its reception power. The terminal 111a reports the measured reception power of the reference signal A to the centralized base station A 201 through a control message for a reception power report (scheme A).

In the following description, control messages may each have a field indicating a message type. For example, a control message for a reception power report (scheme A) defines a message type that indicates a reception power report (scheme A).

Unless information elements contained in each control message are described in detail, they conform to a standard format for control messages.

Each control message that indicates a response to a certain control message may contain, as an information element, a status in which a process resulting from the reception of the certain control message has been succeeded or failed. In the following description, this status may be contained in each response message, as an information element.

If a certain control message contains a unique information element, this information element will be described when the control message is used.

A control message for a reception power report (scheme A) contains, as information elements, a terminal ID, a base station ID for the centralized base station A 201, a radio device ID of the radio device RRH_A 203a, and reception power of a reference signal corresponding to the radio device ID.

When the centralized base station A 201 receives a control message for a reception power report (scheme A), it extracts a radio device ID from the reception power report (scheme A), and identifies a base station B that has transmitted this reception power report (scheme A) through an antenna shared with the radio device corresponding to this radio device ID or in a place close to this radio device by searching a database registered in advance. For example, if the radio device ID of the radio device RRH_A 203a and the base station ID of the base station B 110a are registered in the database, the centralized base station A 201 can identify the base station ID of the base station B 110a from the radio device ID of the radio device RRH_A 203a when receiving the control message for the reception power report (scheme A). If the base station B is registered, there is a probability that the switching to the scheme B will be done, and the following process will accordingly be performed. However, if no base station B is registered, the following process will not be performed.

The centralized base station A 201 performs the process of judging communication stability when the terminal 111a conducts communications using the scheme B, on the basis of the reception power of the reference signals A from the radio device RRH_A 203a which has been reported by the control message for the reception power report (scheme A). This process of judging the communication stability will be described by exemplifying a case where reception power of the terminal 111a for the scheme B is estimated from the reception power for the reference signals A which has been reported during the communications using the scheme A. It should be noted that FIG. 4 shows an example in which the centralized base station A 201 performs the process of judging the communication stability; however this function may be incorporated into the scheme switching server 105 and performed thereby.

Suppose transmission power of a reference signal A at an antenna end of the radio device RRH_A 203a for the scheme A is denoted by TXP_A (dBm), and reception power measured by the terminal 111a is denoted by RXP_A (dBm). In this case, a path loss PL_A (dB) can be expressed by equation 1 described below.

PL_{—}A=TXP_{—}A−RXP_{—}A (Equation 1)

Then, the path loss PL_A for a frequency of the scheme A is corrected with an offset value OFFSET, and a path loss PL_B for a frequency of the scheme B is expressed by equation 2 described below.

PL_{—}B=PL_{—}A+OFFSET (Equation 2)

This offset value is used to compensate for the difference in transmitting characteristics between the frequencies. The offset value may be updated by learning the difference between estimated reception power RXP_B for the scheme B described below and reception power RXP_B actually measured during communications. Suppose the transmission output at the antenna end of the base station B 110a for the scheme B is denoted by TXP_B (dBm). The reception power RXP_B (dBm) of the terminal 111a when communications are conducted using the scheme B can be estimated by equation 3 described below.

RXP_{—}B=TXP_{—}B−PL_{—}B (Equation 3)

The centralized base station A 201 acquires the transmission output TXP_B at the antenna end of the base station B 110a, from operational system parameters that an operator has set in advance through an operational maintenance system. Alternatively, the transmission output TXP_B may be determined using a control message through which the centralized base station A 201 inquires the base station B 110a about the transmission output. If this estimated reception power RXP_B of the terminal 111a for the scheme B is equal to or higher than a preset threshold Thr1 (equation 4), the centralized base station 201 transmits a control message for a scheme B check request to the scheme switching server 105. Thresholds that will be described later are operational system parameters that an operator has set in advance through an operational maintenance system.

RXP_{—}B≧Thr1 (Equation 4)

The control message for the scheme B check request may contain the base station ID of the centralized base station A 201, the base station ID of the base station B 110a identified above, and the terminal ID of the terminal 111a designated by the control message for the reception power report (scheme A).

When the scheme switching server 105 receives the control message for the scheme B check request, it transmits a control message for a scheme B check request response to the centralized base station A 201.

The control message for the scheme B check request may contain the base station ID and the terminal ID designated by the control message for the scheme B check request.

The scheme switching server 105 reports a control message for a scheme B check instruction to the terminal corresponding to the terminal ID designated by the scheme B check request.

The control message for the scheme B check instruction may contain the base station ID of the base station B 110a designated by the control message for the scheme B check request.

When the terminal 111a receives the control message for the scheme B check instruction, it reports a scheme B check instruction response to the scheme switching server 105, and it activates the scheme B system. The control message for the scheme B check instruction response may contain the terminal ID.

The terminal 111a receives reference signals B transmitted regularly from the base station B 110a. If the reception power of a reference signal B is equal to or higher than a preset threshold Thr3, the terminal 111a judges the switching from the scheme A to the scheme B.

Alternatively, if the reception power of the reference signal B is equal to or higher than the preset threshold Thr3 and the identified base station ID is identical to that designated by the control message for the scheme B check instruction when a base station ID can be identified from the reference signal B, the terminal 111a may judge the switching from the scheme A to the scheme B.

If the switching from the scheme A to the scheme B is judged, the terminal 111a transmits a control message for an access request to the base station B 110a. Subsequently, the base station B 110a reports an access request response to the terminal 111a. The terminal 111a establishes a radio link with the base station B 110a, and then transmits a control message for an authentication request to the authentication device (scheme B) 106. When the authentication device (scheme B) 106 receives the control message for the authentication request from the terminal 111a, it identifies whether the terminal 111a is a normal user terminal or not by performing terminal authentication and user authentication using the terminal ID and the user ID. Then, the authentication device (scheme B) 106 reports the identification result to the terminal 111a through a control message for an authentication request response. The terminal 111a receives the control message for the authentication request response from the authentication device (scheme B) 106. If the authentication has been successfully performed, the terminal 111a switches from the scheme A to the scheme B. After that, communications will be conducted using the scheme B.

If the switching between the schemes frequently occurs, the authentication device (scheme B) 106 may store the authentication for a preset time after performing the authentication. This can shorten a time required to respond to an authentication request from the terminal 111a.

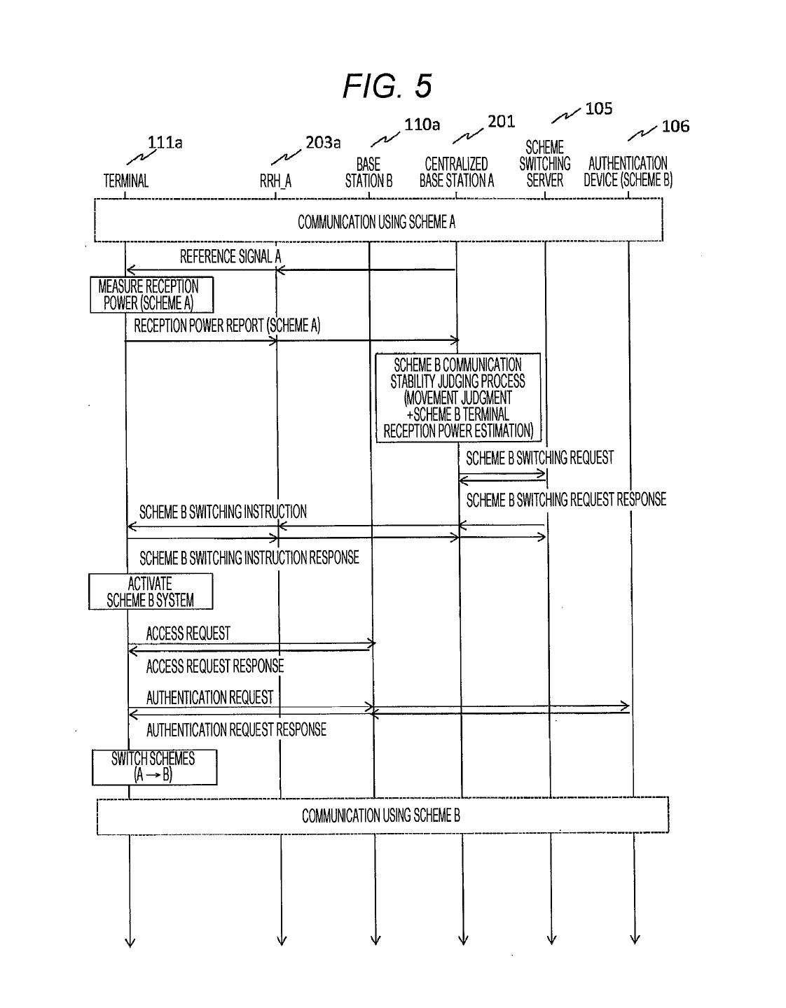

FIG. 5 is an explanatory, operational sequence diagram (Example 2) in Embodiment 1 of the present invention, in which the scheme A is switched to the scheme B.

In FIG. 5, a procedure in which the terminal 111a reports a control message for a reception power report (scheme A) to the centralized base station A 201, and checks the presence of the base station B for the scheme B is substantially the same as in that having been described with reference to FIG. 4. During the process of judging the communication stability of communications using the scheme B, Example 2 utilizes both a movement judging process of judging whether or not the terminal 111a is stably present under the rule of the base station B 110a and a process of assessing the reception power of the terminal 111a in communications using the scheme B. In this way, the stability of the communications using the scheme B is assured on the network side. The reason why the movement judging process is introduced is aiming to consider the following situation. It is assumed that the terminal present under the rule of the centralized base station A 201 is moving quickly. So, even when the switching to the scheme B is done, the terminal may leave the area to which a radio wave from the base station B 110a is delivered. Therefore, introducing the movement judging process in advance increases a probability that the terminal will stay within an area to which a radio wave from the base station B 110a is delivered even after the switching to the scheme B is done. This enables communication stability to be enhanced after the switching.

In the movement judging process, an N number of reception powers RXP_A (dBm) that are reported by reception power reports (scheme A) regarding reference signals A for the scheme A are collected to determine the dispersion SIGMA RXP_A (dBm) of the reception powers RXP_A. If this dispersion is less than a threshold Thr2, it is judged that the terminal 111a has not moved. In this way, it can be judged that the terminal 111a is present stably under the rule of the radio device RRH_A 203a.

SIGMA_RXP_{—}A<Thr2 (Equation 5)

If two conditions are satisfied, namely, if the condition specified by the equation 5 is satisfied and the estimated value RXP_B of reception powers received by the terminal 111a during communications using the scheme B is equal to or higher than the threshold Thr1 as specified by the equation 4, the centralized base station A 201 transmits a control message for a scheme B switching request to the scheme switching server 105.

Information elements in a control message for a scheme B switching request may be substantially the same as those in a control message for a scheme B check request; only the message types of both control messages may differ.

When the scheme switching server 105 receives the control message for the scheme B switching request, it transmits a control message for a scheme B switching request response to the centralized base station A 201.

Information elements in a control message for a scheme B switching request response may also be substantially the same as those in a control message for a scheme B check request response; only the message types of both control messages differ.

The scheme switching server 105 reports a control message for a scheme B switching request instruction to the terminal designated by the terminal ID in the control message for the scheme B switching request.

Information elements in the control message for the scheme B switching request instruction may also be substantially the same as those in the control message for the scheme B check instruction; only the message types of both control messages differ.

When the terminal 111a receives the control message for the scheme B switching request instruction, it reports a scheme B switching request instruction response to the scheme switching server 105, and activates the scheme B system.

Information elements in the control message for the scheme B switching request instruction response may also be substantially the same as those in the control message for the scheme B check instruction response; only the message types of both control messages may differ.

The terminal 111a transmits a control message for an access request to the base station B 110a. Subsequently, the base station B 110a reports a control message for an access request response to the terminal 111a. The terminal 111a establishes a radio link with the base station B 110a, and then transmits a control message for an authentication request to the authentication device (scheme B) 106. When the authentication device (scheme B) 106 receives a control message for an authentication request from the terminal 111a, it identifies whether the terminal 111a is a normal user terminal or not by performing terminal authentication and user authentication using information such as the terminal ID or the user ID. Then, the authentication device (scheme B) 106 reports the identification result to the terminal 111a through a control message for the authentication request response. The terminal 111a receives the control message for the authentication request response from the authentication device (scheme B) 106. If the authentication has been successfully performed, the terminal 111a switches from the scheme A to the scheme B. After that, communications will be conducted using the scheme B.

In FIG. 5, a control message that the centralized base station A 201 reports to the scheme switching server 105 may not be a control message for a scheme B switching request but that for a scheme B check request in FIG. 4. In this case, the operational sequence is the same as the part of the operational sequence in FIG. 4 which is performed after the control message for the scheme B check request is transmitted. The control messages for the scheme B check request and the scheme B switching request differ from each other in the following way. In the flow of the control message for the scheme B check request, the terminal 111a measures the reception power of a reference signal B transmitted from the base station B 110a, and judges the switching from the scheme A to the scheme B. In contrast, in the flow of the control message for the scheme B switching request, the terminal 111a performs an access and the authentication process of switching to the scheme B without making the scheme switching judgment based on the reception power of a reference signal B.

In FIG. 5, the terminal 111a reports the reception power for the scheme A, but may transmit estimated reception power for the scheme B instead. In this case, the terminal 111a needs to know information regarding a transmission output TXP_B of the base station B 110a. Parameters in a SIM card or the like that an operator sells may be preset in the terminal 111a. Otherwise, a standard specification such as 3GPP defines a mechanism for regularly transmitting information regarding surrounding cells as control messages. Through this mechanism, the centralized base station A 201 may regularly report surrounding cell information as control messages. Here, each control message may contain transmission outputs of surrounding base stations. In this case, the terminal 111a can collect information regarding the transmission output TXP_B of the base station B 110a by receiving the control messages reported regularly by the terminal 111a.

In FIG. 5, the centralized base station A 201 performs the process of judging the stability of communications using the scheme B, but this process may be done on the terminal 111a side. In this case, the terminal 111a may collect information regarding the transmission output TXP_B of the base station B 110a in the above manner.

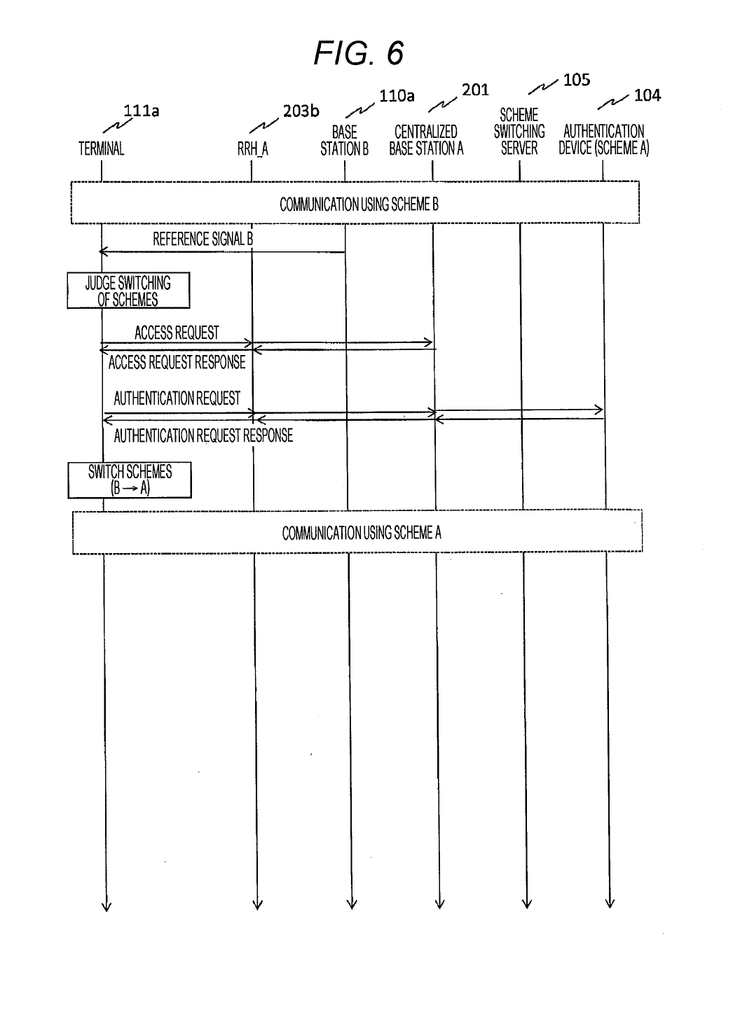

FIG. 6 is an explanatory, operational sequence diagram (Example 1) in Embodiment 1 of the present invention, in which the scheme B is switched to the scheme A. The terminal 111a is conducting communications using the scheme B via the base station B 110a. The terminal 111a receives reference signals B that the base station B 110a regularly transmits, and then makes scheme switching judgment. With regard to the scheme switching judgment, if an average RXP_B (dBm) of an M number of measurement samples that have been acquired from the reception powers of the reference signals B is less than a preset threshold Thr4 (equation 6), the terminal 111a judges the switching from the scheme B to the scheme A.

RXP_{—}B<Thr4 (Equation 6)

In another embodiment, a dispersion SIGMA_RXP_B (dBm) of an L (≧M) number of measurement samples that have been acquired from the reception powers of the reference signals B is equal to or more than a preset threshold Thr5 (equation 7), the terminal 111a judges the switching from the scheme B to the scheme A.

SIGMA_RXP_{—}B≧Thr5 (Equation 7)

Alternatively, if both equations 6 and 7 are satisfied, the terminal 111a may judge the switching from the scheme B to the scheme A.

After making the above scheme switching judgment, the terminal 111a transmits a control message for an access request to the centralized base station A 201. Here, the following description will be given regarding a case where the terminal 111a has moved to a place where the reception power from the base station B 110a is low. If the terminal 111a has moved to the location of a terminal 111b in FIG. 2, it may deviate from the coverage area of the radio device RRH_A 203a. However, since the terminal 111a is still present within the coverage area of the radio device RRH_A 203b, communications using the scheme A are assured. Then, when the terminal 111a attempts to report a control message for an access request to the centralized base station A 201, communications with the centralized base station A 201 are possible via the radio device RRH_A 203b.

When the centralized base station A 201 receives the control message for the access request from the terminal 111a, it reports an access request response to the terminal 111a. The terminal 111a establishes a radio link of the radio device RRH_A 203b with the centralized base station A 201, and then transmits a control message for an authentication request to the authentication device (scheme A) 104. When the authentication device (scheme A) 104 receives the control message for the authentication request from the terminal 111a, it identifies whether the terminal 111a is a normal user terminal or not by performing terminal authentication and user authentication using information such as the terminal ID or the user ID. Then, the authentication device (scheme A) 104 reports the result to the terminal 111a through a control message for an authentication request response. The terminal 111a receives the control message for the authentication request response from the authentication device (scheme A) 106. If the authentication has been successfully performed, the terminal 111a switches from the scheme B to the scheme A. After that, communications will be conducted using scheme A.

### Example 2

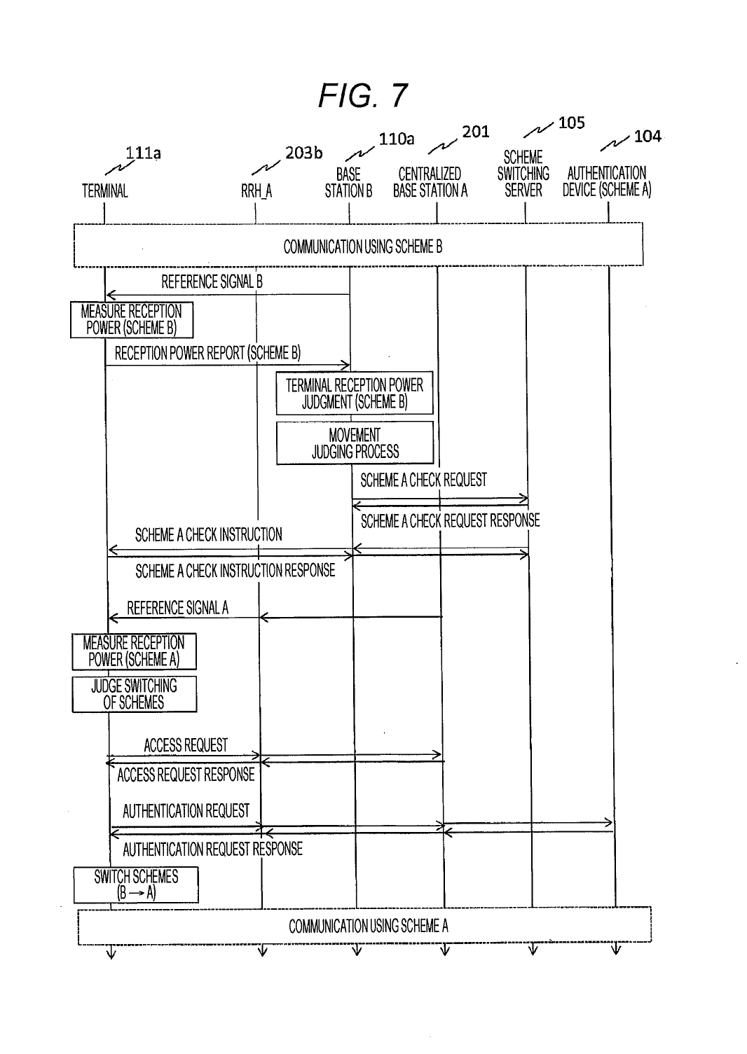

FIG. 7 is an explanatory, operational sequence diagram (Example 2) in Embodiment 1 of the present invention, in which the scheme B is switched to the scheme A.

A control message for a scheme A check request in FIG. 7 contains the same information elements as in the control message for the scheme B check request in FIG. 4, but the types of their control messages differ from each other.

Likewise, information elements are identical but message types are different between respective control messages for the scheme A check request response and the scheme B check request response, for the scheme A check instruction and the scheme B check instruction, and for the scheme A check instruction response and the scheme B check instruction response.

The terminal 111a receives reference signals B that the base station 110a regularly transmits, and measures the reception power of a reference signal B. The terminal 111a reports the measurement result for the reception power to the base station B 110a through a control message for a reception power report (scheme B). When the base station B 110a receives the control message for the reception power report (scheme B), it judges the terminal reception power for the scheme B by using the measurement result and the above equation 6. Subsequently, the base station B 110a performs a movement judging process by using an equation 7. FIG. 7 shows the two judgments using the equations 6 and 7; however only either one of these may be performed.

The base station B 110a performs both the terminal reception power judgment (scheme B) and the movement judging process described above. Then, if the equations 6 and 7 are satisfied, the base station B reports a control message for a scheme A check request to the scheme switching server 105.

When the scheme switching server 105 receives the control message for the scheme A check request, it reports a control message for a scheme A check request response to the base station B 110a. The base station B 110a reports a control message for a scheme A check instruction to the terminal 111a. When the terminal 111a receives the control message for the scheme A check instruction, it reports a control message for a scheme A check instruction response to the scheme switching server 105. Here, the scheme switching server 105 may output the control message for the scheme A check request response to the base station B 110a, after receiving the control message for the scheme A check instruction response.

The terminal 111a starts receiving reference signals A in accordance with the scheme A check instruction. Here, the reference signals A are delivered from the centralized base station A 201 to the terminal 111a via the radio device RRH_A 203b.

The terminal 111a measures the reception power of a reference signal A. The measurement RXP_A of this reception power exceeds a preset threshold Thr6 (equation 8), the terminal 111a judges the switching to the scheme A.

RXP_{—}A≧Thr6 (Equation 8)

After judging the switching to the scheme A, the terminal 111a reports a control message for an access request to the centralized base station A 201 via the radio device RRH_A 203b, and establishes a radio link by receiving a control message for an access request response from the centralized base station A 201.

The terminal 111a establishes a radio link of the radio device RRH_A 203b with the centralized base station A 201, and then transmits a control message for an authentication request to the authentication device (scheme A) 104. When the authentication device (scheme A) 104 receives the control message for the authentication request from the terminal 111a, it identifies whether the terminal 111a is a normal user terminal or not by performing terminal authentication and user authentication using information such as the terminal ID or the user ID. Then, the authentication device (scheme A) 104 reports the result to the terminal 111a through a control message for an authentication request response. The terminal 111a receives the control message for the authentication request response from the authentication device (scheme A) 106. If the authentication has been successfully performed, the terminal 111a switches from the scheme B to the scheme A. After that, communications will be conducted using scheme A.

If the switching between the schemes frequently occurs, the authentication device (scheme A) 104 may store the authentication for a preset time after performing the authentication with the authentication device (scheme A). This can shorten a time required to respond to an authentication request from the terminal 111a.

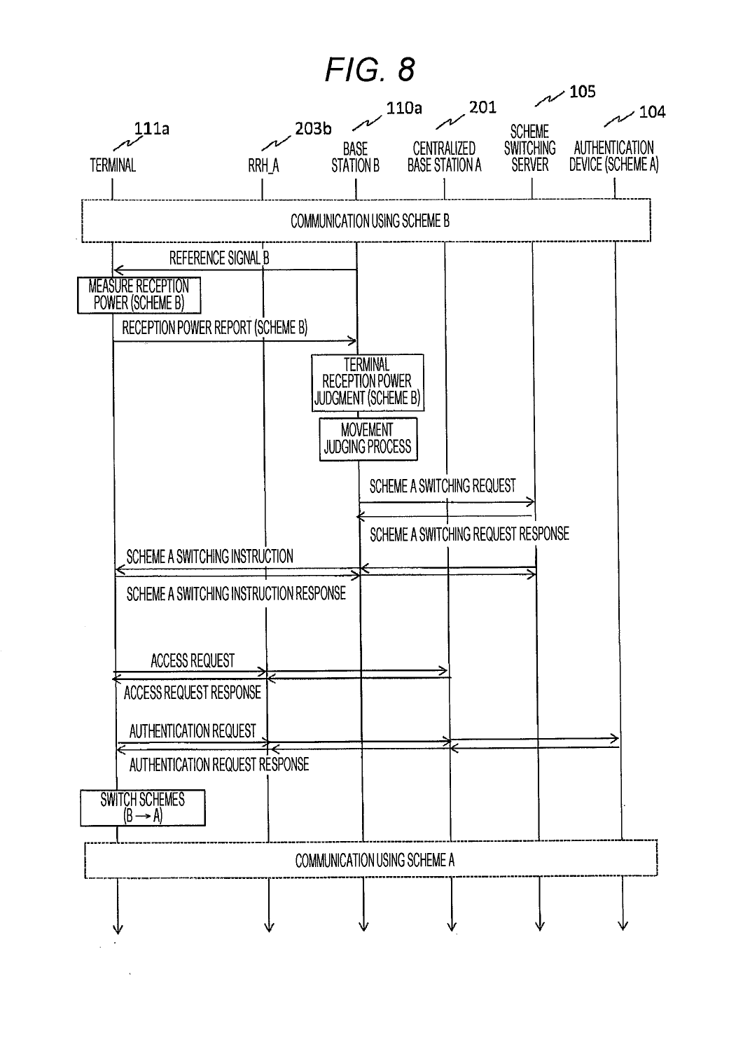

FIG. 8 is an explanatory, operational sequence diagram (Example 3) in Embodiment 1 of the present invention, in which the scheme B is switched to the scheme A.

FIG. 8 differs from FIG. 7 in that the base station 110a reports a control message for a scheme A switching request to the scheme switching server 105, instead of a control message for a scheme A check request.

The control message for the scheme A switching request in FIG. 8 contains the same information elements as in the control message for the scheme B switching request in FIG. 5, but the types of their control messages differ from each other.

Likewise, information elements are identical but message types are different between respective control messages for the scheme A switching request response and the scheme B switching request response, for the scheme A switching instruction and the scheme B switching instruction, and for the scheme A switching instruction response and the scheme B switching instruction response.

When the scheme switching server 105 receives a control message for a scheme A switching request, it reports a control message for a scheme A switching request response to the base station B 110a. Then, the scheme switching server 105 reports a control message for a scheme A switching instruction to the terminal 111a. When the terminal 111a receives the control message for the scheme A switching instruction, it reports a control message for a scheme A switching instruction response to the scheme switching server 105. Here, the scheme switching server 105 may output the control message for the scheme A switching request response to the base station B 110a, after receiving the control message for the scheme A switching instruction response.

The terminal 111a reports a control message for an access request to the centralized base station A 201 via the radio device RRH_A 203b, in accordance with the scheme A switching instruction. The subsequent process is the same as the part of the operational sequence in FIG. 7 which is performed after the access request is transmitted.

For the terminal 111a, the respective control messages for the scheme A check instruction and the scheme A switching instruction differ from each other in the following way. In response to the scheme A check instruction, the terminal 111a judges whether to switch to the scheme A, whereas in response to the scheme A switching instruction, it directly makes an access request for scheme switching without judging whether to switch to the scheme A.

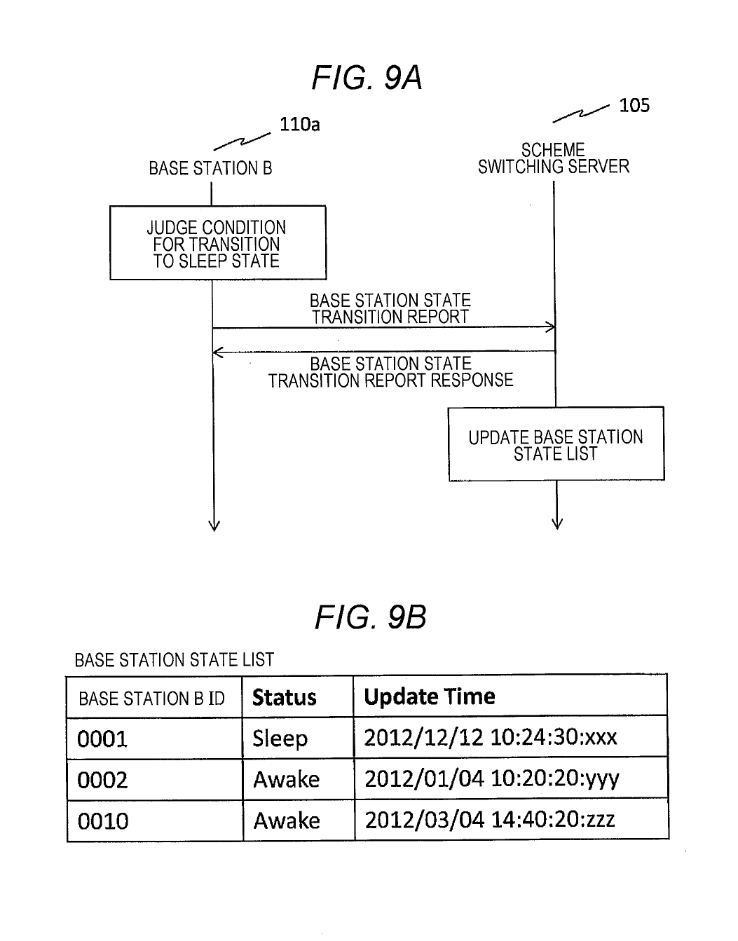

FIG. 9A is an explanation, operational sequence diagram in which the base station B 110a in Embodiment 1 of the present invention transits from an active state to a sleep state.

The base station B 110a assesses a condition for a transition to a sleep state at constant time intervals. The condition for a transition to a sleep state is that no accommodated users are present over at least a predetermined time. Alternatively, if accommodated users have transited from an active state to an idle state and all of these maintain the idle state over at least a predetermined time, the base station B 110a may judge a transition to a sleep state. When the base station B 110a judges a transition to a sleep state, it reports the transition to a sleep state to the scheme switching server 105 through a control message for a base station state transition report.

The control message for the base station state transition report may contain a base station ID and a state of a base station (sleep state or active state).

When the scheme switching server 105 receives the control message for the base station state transition report, it transmits a control message for a base station state transition report response to the base station B 110a, and then updates a base station state list. Alternatively, the scheme switching server 105 may transmit the control message for the base station state transition report response to the base station B 110a, after updating the base station state list.

FIG. 9B is an explanatory view of a base station state list in Embodiment 1 of the present invention.

The base station state list has base stations IDs as indices, and records which each base station is in an active or sleep state. In addition, the base station state list records an update time by using a time stamp at the time of receiving the base station state transition report.

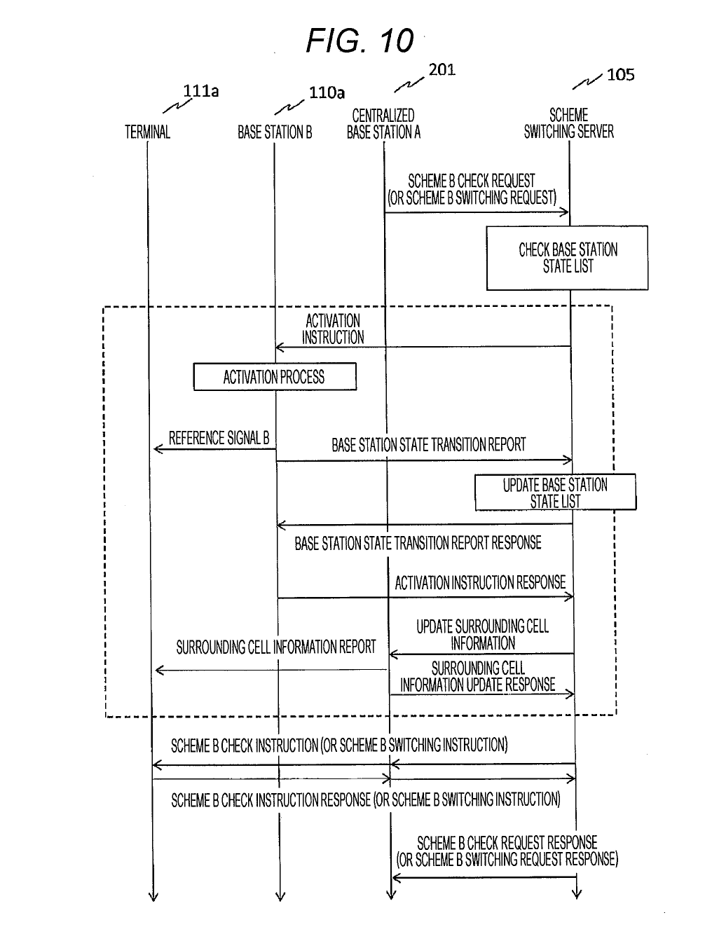

FIG. 10 is an explanatory, operational sequence diagram in which the base station B 110a in Embodiment 1 of the present invention transits from a sleep state to an active state.

The operation in this sequence is triggered when the scheme switching server 105 receives the control message for the scheme B check request from the centralized base station A 201 in FIG. 4 or the control message for the scheme B switching request therefrom in FIG. 5.

When the scheme switching server 105 receives the control message for the scheme B check request or the scheme B switching request from the centralized base station A 201, it checks the base station state list shown in FIG. 9B by using, as a retrieval key, the base station ID of the base station B 110a which is designated by the scheme B check request or the scheme B switching request.

If the base station B 110a is in the sleep state, the scheme switching server 105 transmits a control message for an activation instruction to the base station corresponding to the designated base station ID. This control message for the activation instruction may be configured with any given specific packets that can activate the base station B 110a. For example, the base station B 110a may be powered by Wake On LAN magic packets or some other specific packets.

When the base station B 110a receives the control message for the activation instruction, it performs an activation process. After completing the activation process and entering a state of being able to regularly transmit reference signals B, the base station B 110a reports that it has been in an active state to the scheme switching server 105 through a control message for a base station state transition report.

When the scheme switching server 105 receives the control message for the base station state transition report, it updates the base station state list so that the state of the designated base station ID becomes active. Then, the scheme switching server 105 reports a control message for a base station state transition report response to the base station B 110a.

When the base station B 110a receives the control message for the base station state transition report response, it reports a control message for an activation instruction response to the scheme switching server 105.

In another embodiment, during the activation process, the base station B 110a may transmit the control message for the base station state transition report to the scheme switching server 105 while being in a state of transmitting no reference signals B. Then, the base station B 110a may start transmitting a reference signal B when receiving the control message for the base station state transition report response from the scheme switching server 105. In this case, the base station B 110a reports that it has entered an operational state to the scheme switching server 105 by reporting the control message for the activation instruction response after transmitting the reference signal B.

When the scheme switching server 105 receives the control message for the activation instruction response, it identifies the centralized base station A 201 by using the base station ID designated by the scheme B check request or the scheme B switching request. Then, the scheme switching server 105 transmits a control message for a surrounding cell information update to the identified centralized base station A 201.

The control message for the surrounding cell information update designates the base station ID of the base station B 110a. When the centralized base station A 201 receives the control message for the surrounding cell information update, it updates surrounding cell information, which is one of pieces of information reported regularly, and transmits a control message for a surrounding cell information update response to the scheme switching server 105.

The surrounding cell information is a control message defined in standard specifications such as the 3GPP. When the scheme switching server 105 receives the control message for the surrounding cell information update response, it transmits a control message for a scheme B check instruction or a scheme B switching instruction to the terminal 111a.

The terminal 111a can know the presence of the base station B 110a for the scheme B by receiving the surround cell information reported by the centralized base station A 201. When the terminal 111a receives the control message for the scheme B check instruction or the scheme B switching instruction from the scheme switching server 105, it reports a control message for a scheme B check instruction response or a scheme B switching instruction response to the scheme switching server 105. The subsequent process will conform to the operational sequence described with reference to FIG. 4 or 5.

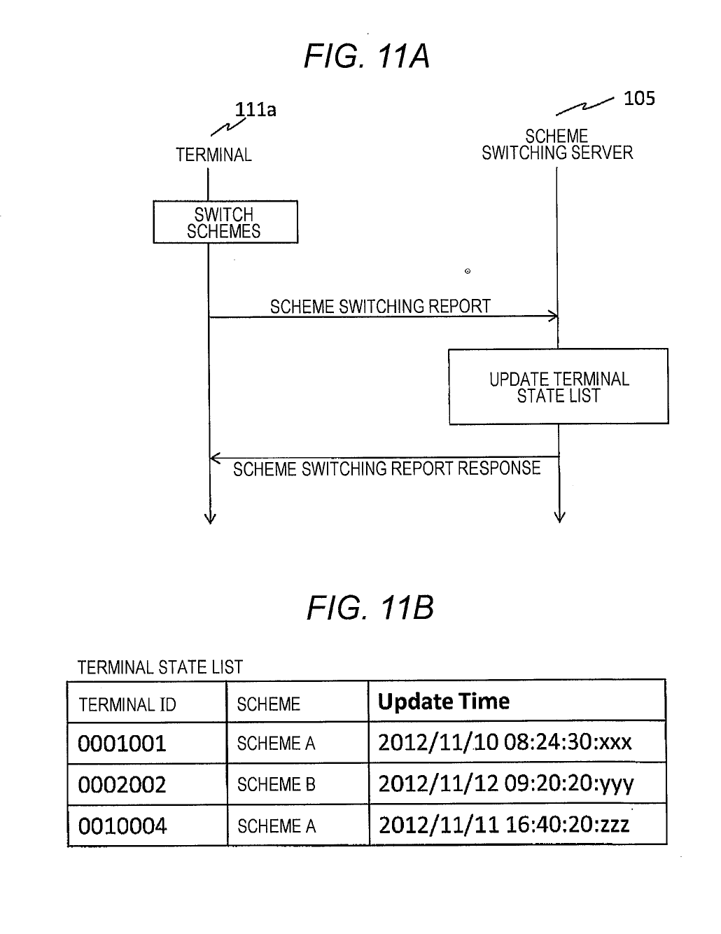

FIG. 11A is an explanatory, operational sequence diagram in which the scheme switching server in Embodiment 1 of the present invention controls terminal states.

After the terminal 111a has successfully switched its communication scheme from the scheme A to the scheme B or from the scheme B to the scheme A, it reports the scheme used in the communications to the scheme switching server 105 through a control message for a scheme switching report.

The control message for the scheme switching report may contain terminal IDs and schemes used by terminals in communications, as information elements.

When the scheme switching server 105 receives the control message for the scheme switching report, it updates a terminal state list, and then transmits a control message for a scheme switching report response to the terminal 111a.

FIG. 11B is an explanatory view of the terminal state list in Embodiment 1 of the present invention. This terminal state list indicates terminals ID and corresponding communication schemes (modes) and update times. Each update time is input with a time stamp when the scheme switching server 105 receives the control message for the scheme switching report and updates the terminal state list. If no update is performed over a predetermined time, this non-updated information element is deleted from the terminal state list.

The function shown in FIGS. 11A and 11B is a network maintenance management function required for a network administrator to recognize communication states of terminals by inquiring the scheme switching server 105. The operational sequence shown in FIG. 11 may not be supported by the scheme switching server 105 and the terminal 111a.

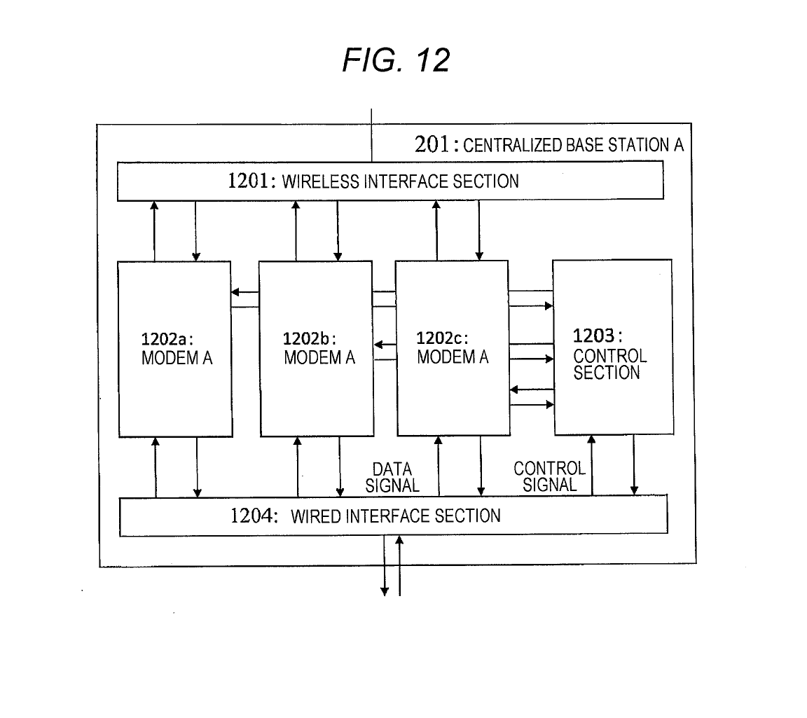

FIG. 12 shows a configuration of the centralized base station A in Embodiment 1 of the present invention. The centralized base station A 201 includes a wireless interface section 1201, modems A1202a, 1202b and 1202c, a control section 1203, and a wired interface section 1204. In this case, the three modems A are described; however one or more modems A may be used.

The wireless interface section 1201 performs the interface process of connecting to, for example, the radio device RRH_A 203a. Each of the modems A1202a, 1202b and 1202c incorporates a digital IQ signal, and functions to connect its output to the output port of a destination such as the radio device RRH_A 203a. More specifically, each modem A functions to generate an electrical digital IQ signal in accordance with an interface, for example, called the CPRI (Common Public Radio Interface), then converts this electrical signal into an optical signal, and communicates with the radio device RRH_A 203a or 203b or the like.

The wired interface section 1204 performs a signal process associated with a wired interface with a backhaul line routed to a base station. For example, the wired interface section 1204 may perform the process of transmitting or receiving Ethernet (registered trademark) signals. If the back haul line routed to a base station is formed of an optical fiber, the wired interface section 1204 subjects an optical signal to a media conversion, converting it to an Ethernet signal, and then this signal is coupled to the wired interface section 1204.

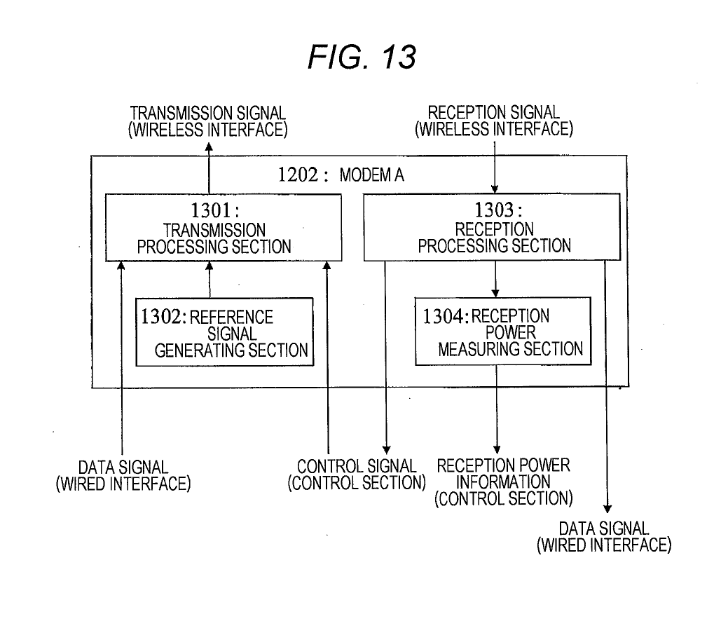

FIG. 13 shows a configuration of each modem A in the centralized base station A 201 in Embodiment 1 of the present invention. A modem A 1202 includes a transmission processing section 1301, a reference signal generating section 1302, a reception processing section 1303, and a reception power measuring section 1304.

The transmission processing section 1301 performs the process of transmitting reference signals generated by the reference signal generating section 1302, data signals received from the wired interface section 1204, and control signals (control messages) received from the control section 1203. The transmission processing section 1301 performs the signal process in accordance with specifications defined by a standard communication scheme, and reports digital IQ transmission signals to a wireless interface.

The reception processing section 1303 receives digital IQ reception signals from the wireless interface, and performs a signal process in accordance with specifications defined by a standard communication scheme. The control signals are reported to the control section 1203; the data signals are reported to the wired interface section 1204.

The reception power measuring section 1304 functions to measure the reception power of a reference signal or a data signal that a terminal has transmitted through an uplink. The measured reception power is reported as reception power information of the control section 1203.

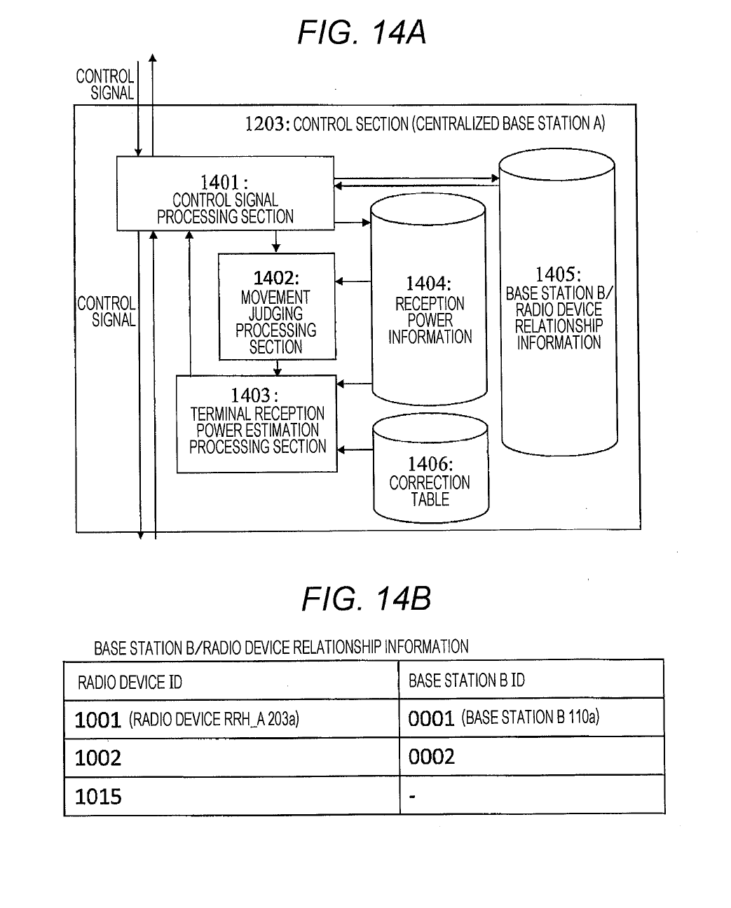

FIG. 14A is an explanatory view showing the control section in the centralized base station A 201 in Embodiment 1 of the present invention.

The control section 1203 includes a control signal processing section 1401, a movement judgment processing section 1402, and a terminal reception power estimation processing section 1403. In addition, the control section 1203 has databases with reception power information 1404, base station B/radio device related information 1405, and a correction table 1406.

The control signal processing section 1401 performs the process of transmitting or receiving control messages in accordance with a standard communication protocol and the above operational sequence.

The movement judgment processing section 1402 performs the movement judging process that uses the dispersion of reception powers which is determined by equation 5 described above.

The terminal reception power estimation processing section 1403 performs the process of estimating the reception power of a terminal for the scheme B which has been described with reference to equations 1 to 4 described above.

FIG. 14B is an explanatory database with a base station B/radio device related information in Embodiment 1 of the present invention. More specifically, FIG. 14B shows a relationship between radio device IDs and base station B IDs. For example, assuming that the radio device ID 1001 indicates the radio device RRH_A 203a, and the base station BID 0001 indicates the base station B 110a, the database indicates that both the radio device RRH_A 203a and the base station B 110a transmit signals by using the same antenna or at respective places positioned close to each other. The definition “places positioned close to each other” is that these places are positioned close to each other to the extent that the difference between respective reception powers measured is equal to or lower than a preset threshold. Data in the database with the base station B/radio device related information may be input by a network operator through a maintenance device as system parameters, or automatically registered in the method that will be described later.

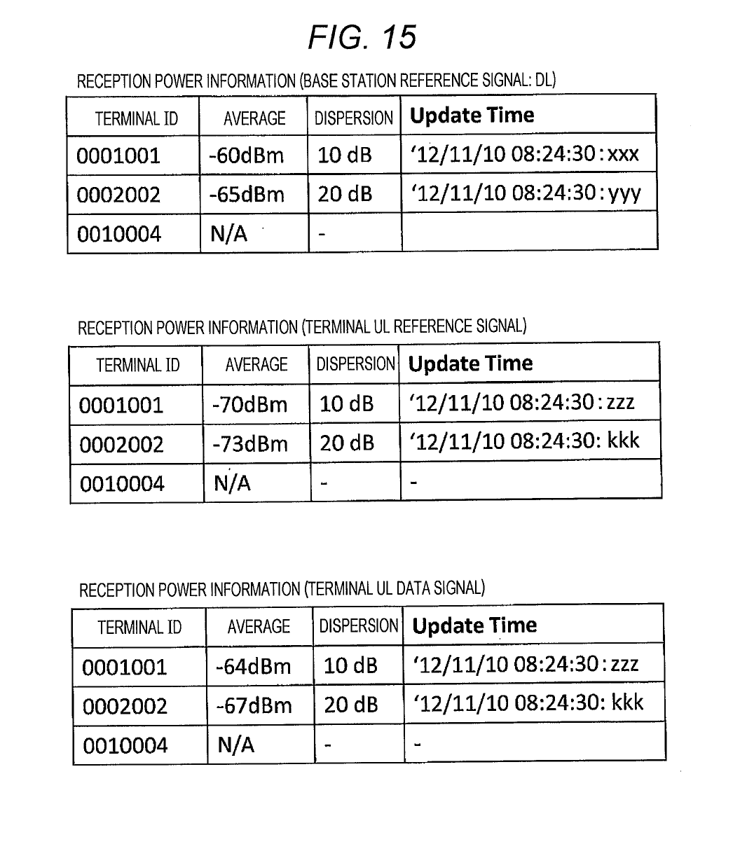

FIG. 15 is an explanatory view showing reception power information in the control section in the centralized base station A 201 in Embodiment 1 of the present invention.

The reception power is classified into the following three types. A terminal measures the reception power of a reference signal transmitted from a base station, and reports this measurement to the centralized base station A 201 through a control message. The first type is based on this measurement. A terminal transmits a reference signal through an uplink, and the reception power measuring section 1304 in the modem A in the centralized base station A 201 measures the reception powers of this reference signal. The second type is based on this reception power. A terminal transmits a data signal through an uplink, and the reception power measuring section 1304 in the modem A in the centralized base station A 201 measures the reception power of this data signal. The third type is based on this reception power.

The control section 1203 in the centralized base station A 201 determines the respective averages and dispersions of measurements for each terminal ID. One exemplary method of determining an average is a method of simply averaging samples acquired for a predetermined time or a moving average method of multiplying a latest sample by a coefficient k and multiplying a past average by (1−k) to sum these resultant values. The dispersion is also determined from samples acquired for a predetermined time. The time when the last sample data have been acquired may be held, and this holding time may be measured by a time stamp, so that data elements that have acquired at least before a predetermined time can be discarded.

A network operator may determine which of the above three types is to be used, by using system parameters and a configuration.

Alternatively, the three types of data may be multiplied by respective predetermined coefficients, and the sum of these may be used. Specifically, assuming the coefficients are denoted by k1, k2 and k3, and the averages of the reception powers are denoted by x1, x2 and x3, x determined by equation 9 may be used as the averages of the reception powers.

X=k1×x1+k2×x2+k3×x3

The dispersion may also be determined by a method using the same coefficients.

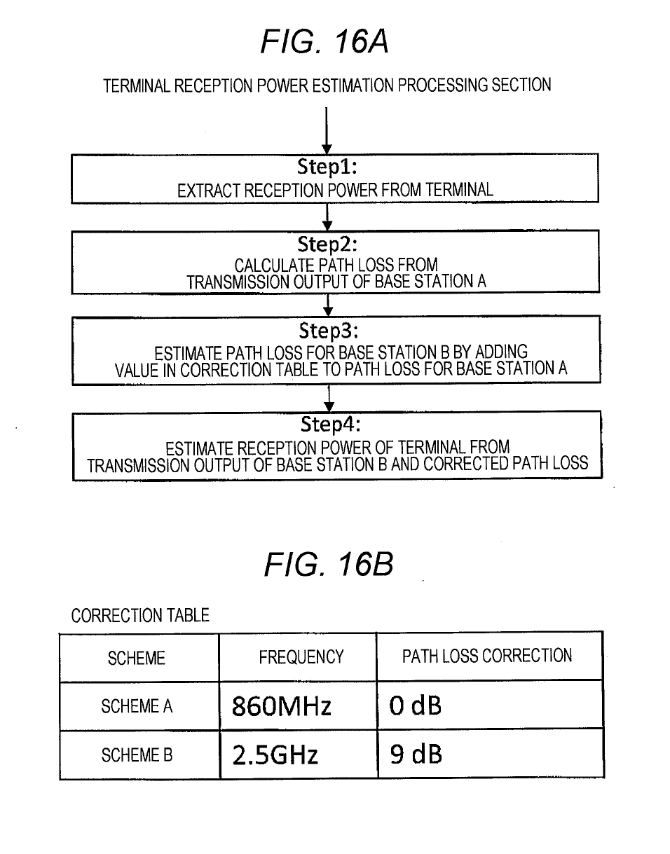

FIG. 16A is an explanatory flowchart of processing performed by the terminal reception power estimation processing section, which the control section in the centralized base station A in Embodiment 1 of the present invention has.

At Step1, the reception power of a terminal is extracted from the database with the reception power information shown in FIG. 15.

At Step2, the path loss is determined from the difference between the transmission output of a base station A and the reception power, as expressed by equation 1.

At Step3, values in the correction table which correspond to different frequencies for the schemes are added to the path loss for the base station A, as expressed by equation 2. As a result, the estimated path loss for a base station B is determined.

At Step4, the estimated reception power from the base station B in the terminal is determined from the transmission output of the base station B and the corrected path loss, as expressed by equation 3.

FIG. 16B is an explanatory database with a correction table 1406 in the terminal reception power estimation processing section, which the control section in the centralized base station A in Embodiment 1 of the present invention has. The database has frequencies corresponding to schemes and path losses to be added at Step3 in FIG. 16A as elements. Data in this table may be set by a network operator, as system parameters.

In another embodiment, a method of updating OFFSET by learning the difference between the estimated reception power RXP_B1 for the scheme B determined by equation 4 and the reception power RXP_B2 actually measured by a terminal during communications using the scheme B will be described. In FIG. 4, the centralized base station A 201 stores the estimated reception power RXP_B1 for the scheme B which has been estimated in the terminal reception power estimation (scheme B), together with the terminal ID. In addition, the centralized base station A 201 stores the reception power measurement result of the reference signal B which has been measured by the terminal 111a, together with the base station ID. The stored reception power will be reported to the centralized base station A 201 as a control message, when the terminal 111a switches communications from the scheme B to the scheme A next time. For example, the terminal 111a may add the reception power RXP_B2 of the reference signal B, which has been measured upon switching to the scheme B, to a control message for a reception power report (scheme A) as an information element. This enables the centralized base station A 201 to know the difference between RXP_B1 and RXP_B2 that are related to the terminal ID. As a result, the control section in the centralized base station A 201 can update OFFSET to be corrected by equation 10.

OFFSET(n+1)=a×(RXP_{—}B1−RXP_{—}B2)+(1−a)×OFFSET(n) (Equation 10)

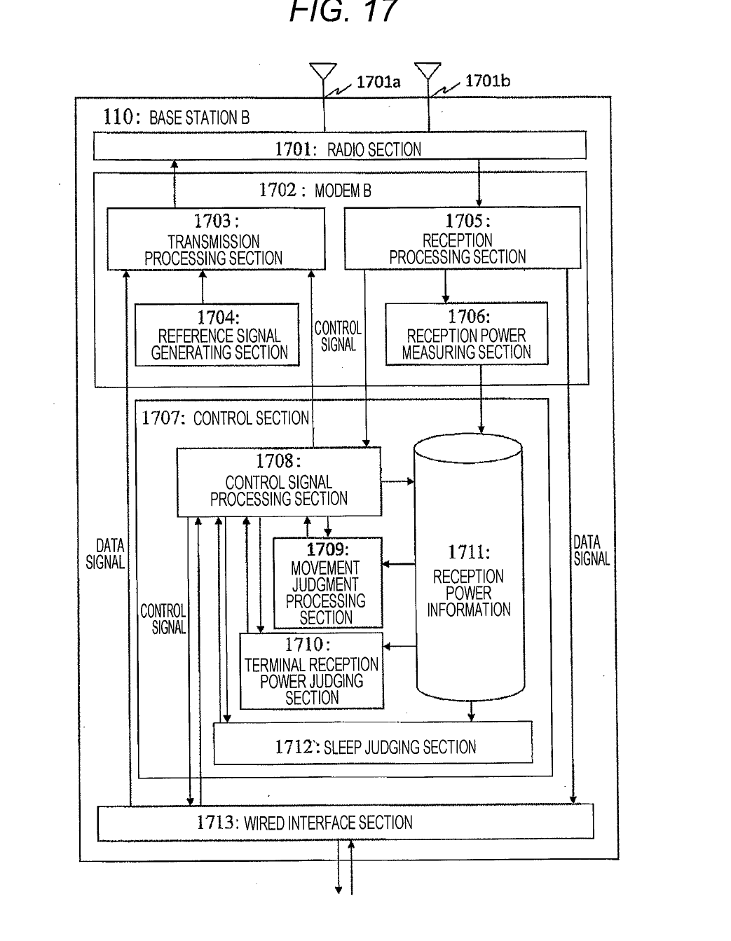

FIG. 17 shows a configuration of the base station B in Embodiment 1 of the present invention.

The base station B 110a includes antennas 1701a and 1701b, a radio section 1701, a modem B 1702, a control section 1707, and a wired interface section 1713. Each of the antennas 1701a and 1701b transmits or receives radio signals.

The radio section 1701 functions to receive a digital IQ signal from the modem B 1702, then converts this digital signal into an analog signal, and transmits it as a radio signal. In addition, the radio section 1701 functions to receive a radio signal from the antenna 1701a or 1701b, converting it from an analog signal to a digital signal and creating a digital IQ signal, and pass it to a modem B 1502 as a reception signal. Moreover, functions of a signal amplifier, a band-pass filter, and the like are incorporated therein.

The modem B 1702 conforms to standard specifications for the scheme B, and its basic function is substantially the same as that of the modem A for the scheme A which has been described with reference to FIG. 13.

The control section 1707 includes a control signal processing section 1708, a movement judgment processing section 1709, a terminal reception power judging section 1710, and a sleep judging section 1712. In addition, the control section 1707 has a database with reception power information 1711.

The control signal processing section 1708 performs the process of transmitting or receiving control messages in accordance with a standard communication protocol defined for the scheme B and the above operational sequence.

The movement judgment processing section 1709 performs the movement judging process shown in FIG. 7 or 8 by using the dispersion of reception powers which is determined by equation 7 described above.

The terminal reception power judging section 1710 detects a variation among the reception powers in communications using the scheme B which has been described with reference to equation 6 described above. Then, the terminal reception power judging section 1710 performs the process of the terminal reception power judgment (scheme B) shown in FIG. 7 or 8.

The database with the reception power information 1711 is substantially the same as that having been described with reference to FIG. 15. A network operator may determine which of the above three types is to be used, by using system parameters and a configuration. Alternatively, the value determined by equation 9 may be used for the three types of data.

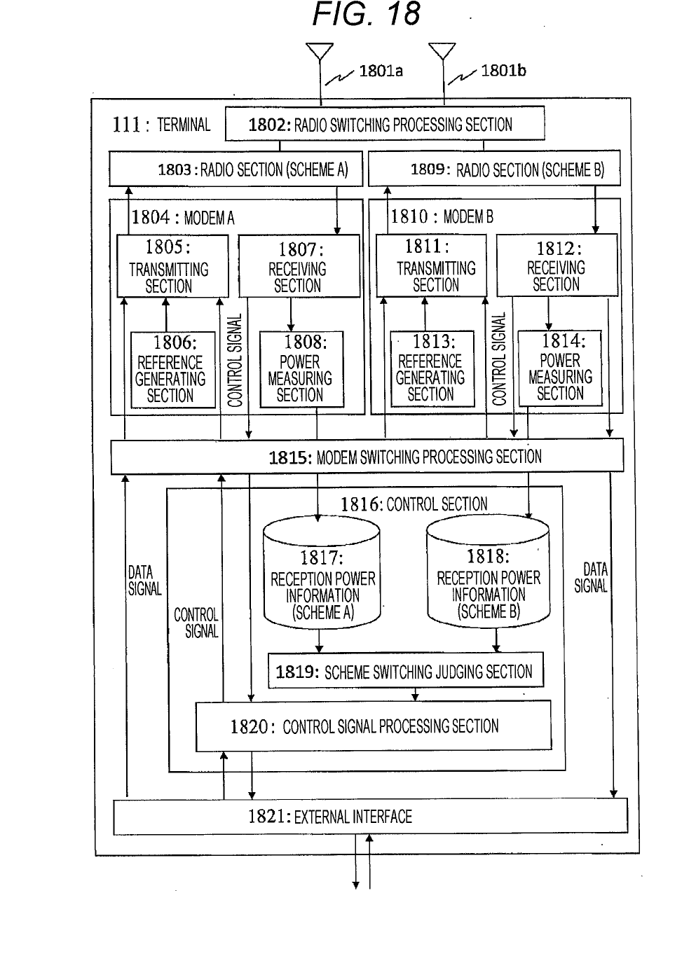

FIG. 18 shows a configuration of a terminal 111 in Embodiment 1 of the present invention.

The terminal 111 includes antennas 1801a and 1801b, a radio switching processing section 1802, a radio section (scheme A) 1803, a modem A 1804, a radio section (scheme B) 1809, a modem B 1810, a modem switching processing section 1815, a control section 1816, and an external interface 1821.

The radio switching processing section 1802 performs the process of switching between the radio section (scheme A) 1803 and the radio section (scheme B) 1809, such that a radio transmission/reception signal for the antenna 1801a or 1801b is connected to an either one of the radio section (scheme A) 1803 and the radio section (scheme B) 1809. This switching process is performed as the result of the process performed by a control signal processing section 1820 in the control section 1816 and in accordance with the operational sequences shown in FIGS. 4 to 8.

The radio section (scheme A) 1803 functions to receive a digital IQ signal from the modem A 1804, then convert this digital signal to an analog signal, and transmit it as a radio signal. In addition, the radio section (scheme A) 1803 functions to convert an analog radio reception signal from the antenna 1801a or 1801b into a digital signal, creating a digital IQ signal, and pass it to the modem A 1804 as a reception signal. Moreover, functions of a signal amplifier, a band-pass filter, and the like are incorporated therein.

The radio section (scheme B) 1809 has substantially the same function as in the radio section (scheme A) 1803. However, they differ in frequency, band-pass filter characteristics, and the like, depending on the corresponding schemes, or schemes A and B.

The modem A 1804 is equipped with a terminal-side modem function that conforms to standard specifications for the scheme A, and has substantially the same configuration as in the modem A for the scheme A described with reference to FIG. 13. Likewise, the modem B 1810 is equipped with a terminal-side modem function that conforms to standard specifications for the scheme B, and has substantially the same configuration as in the modem A for the scheme A described with reference to FIG. 13.

The modem switching processing section 1815 performs the process of switching between the modem A 1804 and the modem B 1810, such that data signals to be transmitted to or received from the external interface 1821 or control signals to be transmitted to or received from the control section 1816 are connected to an either one of the modem A 1804 and the modem B 1810.

This switching process is performed as the result of the process performed by a control signal processing section 1820 in the control section 1816 and in accordance with the operational sequences shown in FIGS. 4 to 8.

The control section 1816 includes a control signal processing section 1820 and a scheme switching judging section 1819. The control section 1816 also has reception power information (scheme A) 1817 and reception power information (scheme B) 1818 as databases.

The control signal processing section 1820 performs the process of transmitting or receiving control messages in accordance with a standard communication protocol defined for the scheme A or B and the above operational sequence.

The scheme switching judging section 1819 performs the scheme switching judgment shown in FIGS. 4, 6 and 7.

The external interface 1821 serves as an interface that connects to external speakers or an external microphone when an audio signal is handled, or that exchanges data signals with an external communication apparatus when data communications are conducted.

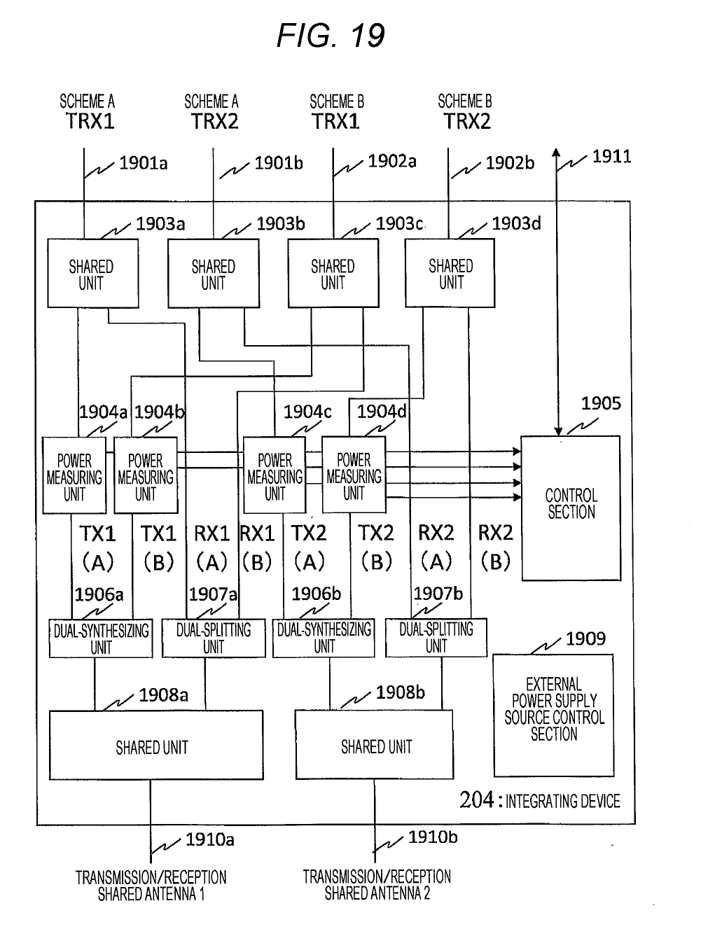

FIG. 19 is an explanatory view showing the integrating device in Embodiment 1 of the present invention.

The integrating device 204 includes: scheme A transmitting/receiving antennas 1901a and 1901b; scheme B transmitting/receiving antennas 1902a and 1902b; antenna shared units 1903a, 1903b, 1903c and 1903d; power measuring units 1904a, 1904b, 1904c and 1904d; dual-synthesizing units 1906a and 1906b; dual-splitting units 1907a and 1907b; shared units 1908a and 1908b; a control section 1905, an external power supply source control section 1909, and an external communication port 1911.

In another embodiment, one or more of the power measuring units 1904a, 1904b, 1904c and 1904d, the control section 1905, and the external power supply source control section 1909 may be omitted.

Each of the shared units 1903a, 1903b, 1903c, 1903d, 1908a and 1908b is an antenna shared unit by which transmitting/receiving antennas are shared among radio devices. Each of the dual-synthesizing units 1906a and 1906b synthesizes transmission signals for schemes A and B; each of the dual-splitting units 1907a and 1907b splits a reception signal into those for the schemes A and B.

Each of the power measuring units 1904a, 1904b, 1904c and 1904d measures the power of a transmission signal, the center frequency and bandwidth of which have been designated. If the measured power exceeds a preset threshold Thr7, each power measuring unit reports the detection of a radio wave to the control section 1905. If the measured power is lower than another preset threshold Thr8, each power measuring unit reports that the emission of a radio wave has been stopped to the control section 1905.

In the above way, the control section 1905 can oversee the state where signals for the scheme A or B are transmitted or received over a predetermined time.

The control section 1905 oversees the state regarding whether or not radio waves based on the signals detected by the power measuring units 1904a, 1904b, 1904c and 1904d are detected in the scheme A transmitting/receiving antennas 1901a and 1901b and the scheme B transmitting/receiving antennas 1902a and 1902b. In addition, the control section 1905 stores a time when a radio wave is detected or stopped, by using a time stamp. When this time stamp measures at least a predetermined time interval, the control section 1905 confirms the state by reading the powers measured by the power measuring units 1904a, 1904b, 1904c and 1904d, and then updates it.

The external communication port 1911 serves as a communication port for Ethernet signals. The external communication port 1911 is used to inquire the control section 1905 about the state of power detection from the outside.

The external power supply source control section 1909 functions to power the base station B 110a connected to the integrating device 204 when receiving special packets for power supply from the outside.

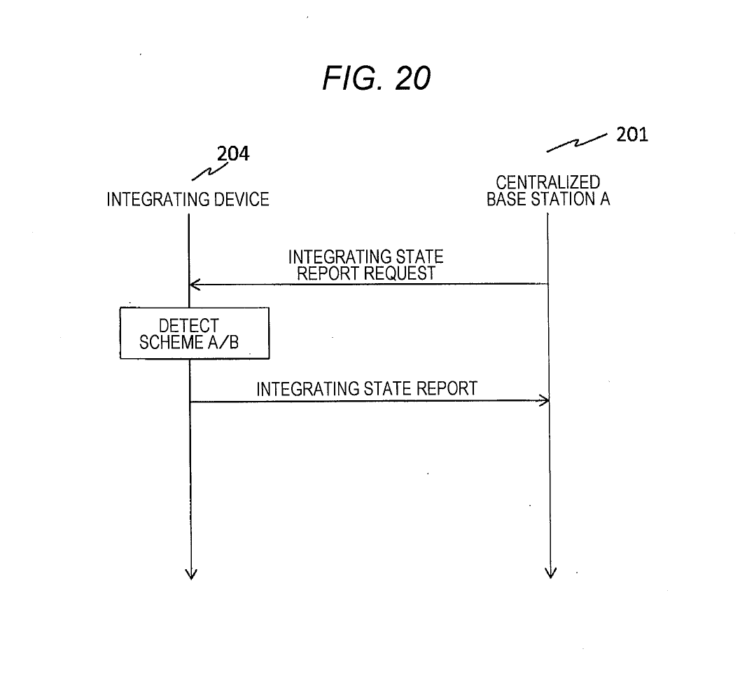

FIG. 20 is an explanatory, operational sequence diagram of inquiring the integrating device in Embodiment 1 of the present invention about a detected scheme. The centralized base station A 201 reports a control message for an integrating state report request to the integrating device 204. If a control message is intended to be transmitted to an integrating device with a specific IP address, the centralized base station A 201 needs to hold the IP address of the integrating device 204. If the centralized base station A 201 does not manage the IP address of the integrating device 204, it may transmit the control message through a broadcast message.

When the integrating device 204 receives the control message for the integrating state report request, it detects an integrating state, for example, where only a transmission signal for the scheme A, only a transmission signal for the scheme B, both transmission signals for the schemes A and B, or none of these has been detected, as described with reference to FIG. 19.

The integrating device 204 reports a control message for an integrating state report which contains the detected integrating state as an information element, to the centralized base station A 201. In this way, the centralized base station A 201 can automatically identify whether or not the antennas are integrated and used.

If the embodiment in FIG. 20 is not supported, a method that holds a table in which a network operator registers system parameters regarding whether the radio device RRH_A for the scheme A and the base station for the scheme B are integrated or not may be employed.

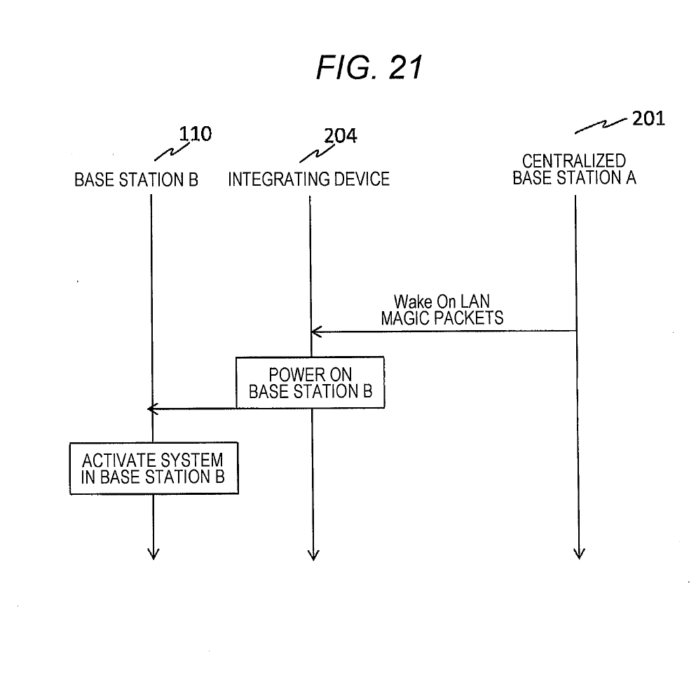

FIG. 21 is an explanatory, operational sequence diagram in which the base station B in Embodiment 1 of the present invention is powered.

The centralized base station A 201 transmits Wake On LAN magic packets to the integrating device 204. When the integrating device 204 receives the magic packets, it activates a power source, from which the external power supply source control section 1909 will supply power to the base station B 110a. This can provide a mechanism for activating the system in the base station B 110a.

If the base station B 110a is provided with no mechanism for the activation responding to the Wake On LAN magic packets, the centralized base station A 201 may directly transmit the Wake On LAN magic packets to the base station B 110a.

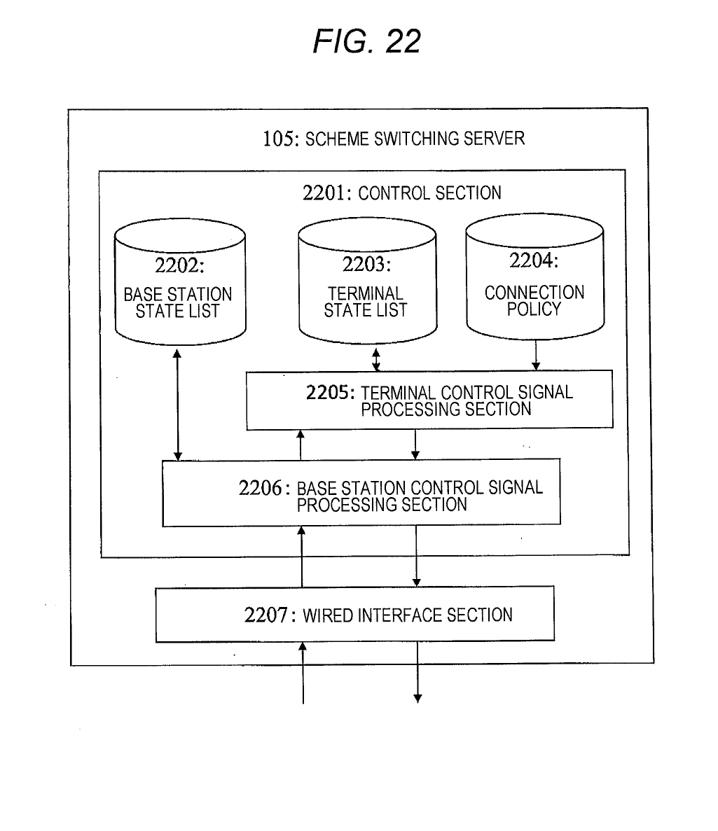

FIG. 22 shows a configuration of the scheme switching server in Embodiment 1 of the present invention.

The scheme switching server 105 includes a control section 2201 and a wired interface section 2207. The wired interface section 2207 performs the interface process of communicating with the outside such as Ethernet.

The control section 2201 includes a control signal processing section 2206 and a terminal control signal processing section 2205, and holds databases with a base station state list 2202, a terminal state list 2203, and a connection policy 2204.

In the above operational sequence, the terminal control signal processing section 2205 exchanges control messages with a terminal.

In the above operational sequence, the base station control signal processing section 2206 exchanges control messages with a base station.

The base station state list 2202 has been described with reference to FIG. 9B.

The terminal state list 2203 has been described with reference to FIG. 11B.

The connection policy 2204 is a database that is the same as the connection policy of ANDSF described in 3GPP TS 24.312 V11.4.0 (2012-09), “Access Network Discovery and Selection Function (ANDSF) Management Object (MO)”, p. 11-74.

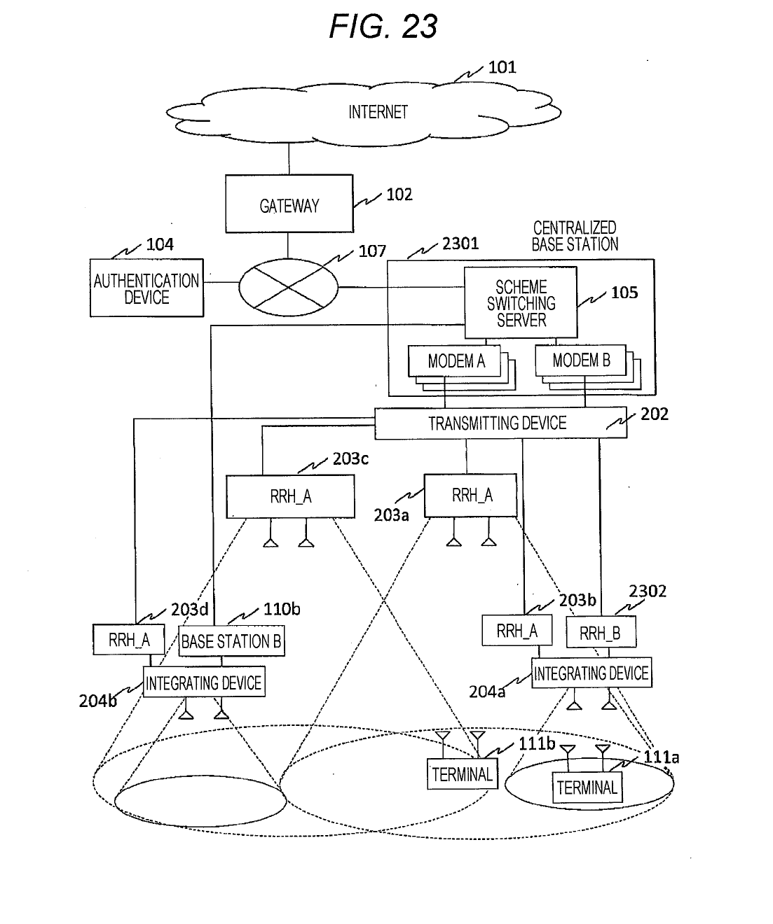

FIG. 23 shows a system configuration of Embodiment 3 of the present invention.

The function of the base station B 110a in FIG. 2 is separated into those of modems B and a radio device RRH_B 2302. The functions of the modems B in the base station B 110a are incorporated into a centralized base station 2301; the function of the scheme switching server 105 is also incorporated into the centralized base station 2301. In a certain operational sequence, control messages to be transmitted to the base station B and the scheme switching server 105 can be enclosed inside a device in the centralized base station 2301. Alternatively, the function of the scheme switching server 105 may not be incorporated into the centralized base station 2301.

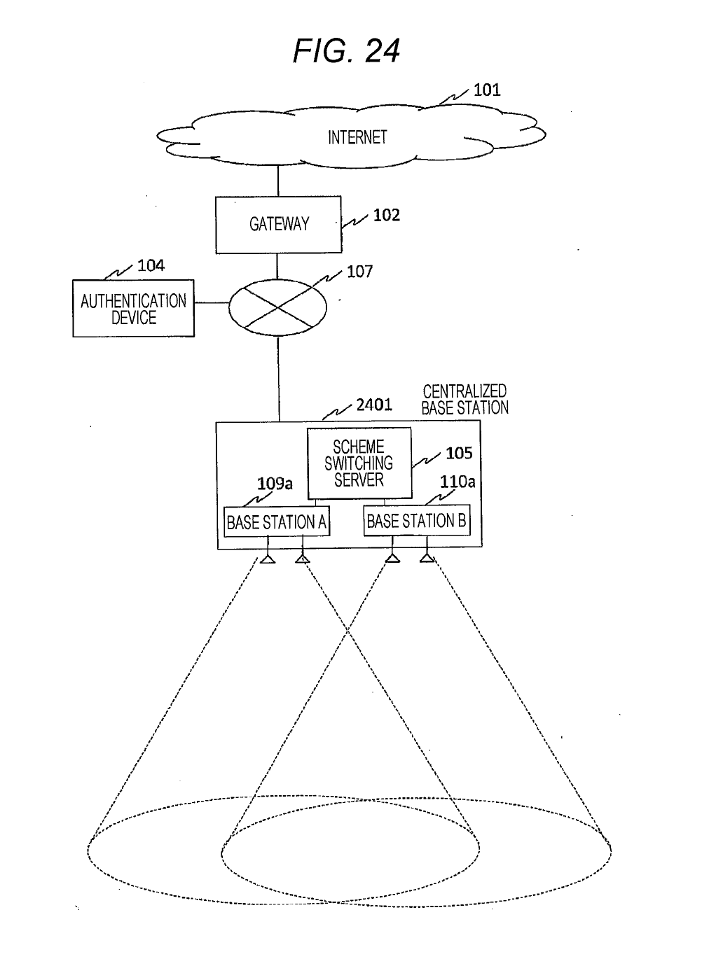

FIG. 24 shows a system configuration of Embodiment 4 of the present invention.

A centralized base station 2401 is equipped with the functions of the scheme switching server 105, the base station A 109a and the base station B 110a. In a certain operational sequence, all control messages can be collected into a device in the centralized base station.

All of Embodiments 1 to 4 enable the above operational sequences to be executed.

1. A communication device that communicates with a terminal by using a first communication scheme, the terminal capable of conducting communications by using the first communication scheme and a second communication scheme, the communication device comprising:
a reception power measuring section receiving first reception power of the terminal for the first communication scheme;
a control section estimating reception power of the terminal for the second communication scheme, on the basis of first transmission power to the terminal for the first communication scheme, the first reception power acquired by the reception power measuring section, and second transmission power to the terminal from a second communication device that conducts communications by using the second communication scheme; and
an output section that outputs information for switching from the communication device to the second communication device, on the basis of a result of the estimation.

2. The communication device according to claim 1, wherein
the control section calculates a first propagation path loss for the first communication scheme, from the first transmission power of the communication device and the first reception power of the terminal, and estimates the reception power of the terminal for the second communication scheme by using the first propagation path loss and the second transmission power of the second communication device during communications using the second communication scheme, and
when the estimated reception power is equal to or higher than a first value, the output section outputs the information for switching from the communication device to the second communication device, on the basis of a result of the estimation.

3. The communication device according to claim 2, wherein
the control section estimates a second propagation path loss for the second communication scheme by using the first propagation path loss and a preset offset value, and estimates the reception power of the terminal for the second communication scheme by using the second propagation path loss and the second transmission power of the second communication device.

4. The communication device according to claim 3, wherein
the reception power measuring section receives second reception power of the terminal for the second communication scheme from the terminal, the second reception power being used to update the offset value.

5. The communication device according to claim 1, wherein
the control section calculates dispersion of the first reception power of the terminal, and estimates the reception power of the terminal for the second communication scheme when the dispersion is equal to or less than a second value.

6. The communication device according to claim 1, further comprising a database having a relationship between the communication device and the second communication device, in which a difference between second reception power of the terminal and the first reception power of the terminal is equal to or smaller than a third value,
wherein the control section refers to the database when receiving the first reception power of the terminal, and calculates a first propagation path loss for the first communication scheme, from the first transmission power of the communication device and the first reception power of the terminal when the second communication device related to the communication device is present.

7. A radio communication system comprising:
a terminal capable of conducting communications by using a first communication scheme and a second communication scheme; and
a first communication device communicating with the terminal by using the first communication scheme,
wherein the terminal transmits first reception power of the terminal for the first communication scheme, and the first communication device receives the first reception power, estimates reception power of the terminal for the second communication scheme, on the basis of first transmission power to the terminal for the first communication scheme, the received first reception power, and second transmission power to the terminal from a second communication device that conducts communications by using the second communication scheme, and outputs information regarding a result of the estimation.

8. The radio communication system according to claim 7, wherein
the first communication device calculates a first propagation path loss for the first communication scheme, from the first transmission power of the first communication device and the first reception power of the terminal, estimates the reception power of the terminal for the second communication scheme by using the first propagation path loss and the second transmission power of the second communication device during communications using the second communication scheme, and outputs the information regarding the estimation result when the estimated reception power is equal to or higher than a first value.

9. The radio communication system according to claim 8, wherein
the first communication device estimates a second propagation path loss for the second communication scheme by using the first propagation path loss and a preset offset value, and estimates the reception power of the terminal for the second communication scheme by using the second propagation path loss and the second transmission power of the second communication device.

10. The radio communication system according to claim 7, further comprising a database having a relationship between the first communication device and the second communication device, in which a difference between second reception power of the terminal and the first reception power of the terminal is equal to or smaller than a third value,
wherein the first communication device refers to the database when receiving the first reception power, and calculates a first propagation path loss of the first communication device for the first communication scheme when the second communication device related to the first communication device is present.

11. The radio communication system according to claim 7, further comprising an integrating device integrating respective antennas in the first communication device and the second communication device such that the antenna is shared between the first communication scheme and the second communication scheme.

12. The radio communication system according to claim 7, further comprising a radio switching server outputting information for switching from the first communication scheme to the second communication scheme, by using the output information regarding the estimated result.

13. A radio communication method performed by a terminal and a first communication device, the terminal capable of conducting communications by using a first communication scheme and a second communication scheme, the first communication device communicating with the terminal by using the first communication scheme, the radio communication method comprising:
transmitting first reception power of the terminal for the first communication scheme from the terminal;
receiving the first reception power by using the first communication device;
estimating reception power of the terminal for the second communication scheme, on the basis of first transmission power to the terminal for the first communication scheme, the received first reception power, and second transmission power to the terminal from a second communication device that conducts communications by using the second communication scheme; and
outputting information regarding a result of the estimation.

14. The radio communication method according to claim 13, further comprising calculating a first propagation path loss for the first communication scheme from the first transmission power of the first communication device and the first reception power of the terminal, by using the first communication device,
wherein the estimating of the reception power of the terminal for the second communication scheme uses the first propagation path loss and the second transmission power of the second communication device during communications using the second communication scheme, and
the outputting of the information regarding the estimated result is performed when the estimated reception power is equal to or higher than a first value.

15. The radio communication method according to claim 13, further comprising estimating a second propagation path loss for the second communication scheme by using the first propagation path loss and a preset offset value, in the first communication device,
wherein the estimating of the reception power of the terminal for the second communication scheme uses the second propagation path loss and the second transmission power.

16-17. (canceled)
